(19) United States
(12) Patent Application Publication
(10) Pub. No.: US 2012/0197908 A1
(43) Pub. Date: Aug. 2, 2012

(54) METHOD AND APPARATUS FOR ASSOCIATING A TABLE OF CONTENTS AND HEADINGS

(75) Inventor: Yuya Unno, Kanagawa-ken (JP)

(73) Assignee: INTERNATIONAL BUSINESS MACHINES CORPORATION, Armonk, NY (US)

(21) Appl. No.: 13/360,441

(22) Filed: Jan. 27, 2012

(30) Foreign Application Priority Data
Jan. 31, 2011 (JP) 2011018978

(51) Int. Cl. G06F 17/30

(52) U.S. Cl. 707/749; 707/748; 707/E17.069

(57) ABSTRACT

Apparatus to associate a table of contents (TOC) and headings. An input section inputs TOC data C and body data D. A search section seeks the maximum value of a score function S which indicates the likelihood of associations M between a TOC and headings. An output section outputs associations M which maximize the score function S. The score function S is the total of a first sum obtained by summing unigram scores u for all the TOC items, where the unigram score u evaluates the likelihood of association of TOC item with a heading candidate line independently, and a second sum obtained by summing bigram scores b for all pairs of TOC items, where the bigram score b evaluates the likelihood of associations of paired TOC items with heading candidate lines on the basis of a degree of commonality.

### CROSS REFERENCE TO RELATED APPLICATION

This application claims priority under 35 U.S. C. §119 from Japanese Patent Application No. 2011-018978 filed Jan. 31, 2011, the entire contents of which are incorporated herein by reference.

### FIELD OF THE INVENTION

The subject matter herein relates to an automated technique for associating a table of contents and headings in a body in a computerized book and involves arithmetic processing by a computer, processor or the like.

### BACKGROUND

Recently, the computerization of books is increasing its momentum at home and abroad, and a great many books are being computerized. In the computerization of documents such as books, it is desirable to enjoy the merit of computerization to the maximum by attaching appropriate structure information to text data after the text data is acquired by an optical character reader (OCR). An example of the structure information for enhancing value of computerized books is an association between a table of contents and headings in a body. By attaching information about the association between a table of contents and headings, it is possible, for example, to provide a link to a corresponding heading in a body from the table of contents, decide the order of reading sentences in the body, and perform weighting at the time of search with more importance attached to the headings than to the body.

It is possible manually to attach the information about an association between a table of contents and headings in a body. However, in view of computerization in institutions having many books, such as a library, it is impractical to attach the information manually.

As a prior-art technique for automatically associating a table of contents with headings in a body, there has been Japanese Patent Laid Open No. 2007 226792 (Citation 1). This reference discloses, as a condition for recognizing the table of contents, a text similarity condition that each item in a table of contents and another text fragment combined and linked to the item, for example, a heading should be similar in their text contents. However, even if the text similarity condition is satisfied, there is a problem that, for example, in the case where the same sentence as a chapter heading or a section heading is included in a body, it is not clear which sentence is the heading to be linked to an item in a table of contents.

Therefore, Citation 1 discloses a technique for recognizing a text fragment appearing to be an item in a table of contents, a text fragment appearing to be the link destination thereof or both of them after selectively excluding text fragments from candidates by comparison with a reference format. More specifically, Citation 1 discloses a technique for excluding text fragments which are not in accordance with an index part format, text fragments which do not include a keyword indicating being a heading and text fragments which include lower case alphabet letters from heading candidates.

Furthermore, Citation 1 discloses a technique for recognizing a text fragment appearing to be a link destination of an item in a table of contents after limiting candidates on the basis of a position in a page associated with each text fragment. As a condition for reducing the number on the basis of a position in a page, there are disclosed a condition that only a text fragment existing within a predetermined distance from the top of the page is set as a heading candidate, and a condition that only a text fragment associated with a column number indicating the leftmost column of the page is set as a heading candidate.

Patent Citations 2 (Japanese Patent Laid-Open No. 2000-148788), 3 (Japanese Patent Laid-Open No. 10-260993), 4 (Japanese Patent Laid-Open 2001-34763), 5 (Japanese Patent Laid-Open No. 2003-16076), and 6 (Japanese Patent Laid-Open 2003-58556) disclose a technique for automatically extracting a character string area with a lot of points as a title by using title-specific characteristics as points, for the purpose of extracting a title.

### BRIEF SUMMARY

The disclosed subject matter includes a method for association between a table of contents and headings for associating a table-of-contents item in a table of contents of a document with a heading line in a body of the document by processing by a computer. This includes electronically receiving table-of-contents data C of the document for each table-of-contents item and electronically receiving body data D of the document for each line. The method also includes computer searching for a maximum value of a score function S that indicates the likelihood of associations M of all table-of-contents items in the table-of-contents data C with heading candidate lines that are lines as heading candidates in the body data D and that is a function of C, D and M. The disclosed method includes electronically outputting the associations M that maximize the score function S. The score function S is determined as the total of a first sum obtained by summing up unigram scores u for all the table-of-contents items. The unigram score u evaluates the likelihood of association of each table-of-contents item with a heading candidate line independently. A second sum is obtained by summing up bigram scores b for all pairs of table-of-contents items. The bigram score b evaluates the likelihood of associations of paired table-of-contents items, which are a pair of one table-of-contents item and another table-of-contents item, with heading candidate lines on the basis of the degree of commonality between the associations of the paired table-of-contents items with the heading candidate lines.

The disclosed subject matter also includes an apparatus for association between a table of contents and headings for associating a table-of-contents item in a table of contents of a document with a heading line. The apparatus includes an input section for inputting table-of-contents data C for each table-of-contents item of the document and body data D for each line of the document. It also includes a search section for searching for the maximum value of a score function S that indicates the likelihood of associations M of all table-of-contents items in the table-of-contents data C with heading candidate lines that are lines as heading candidates in the body data D and that is a function of C, D and M. The disclosed apparatus further includes an output section for outputting the associations M that maximize the score function S. In the disclosed apparatus, the search section determines the score function S as the total of (a) a first sum obtained by summing up unigram scores u for all the table-of-contents items, the unigram score u evaluating the likelihood of association of each table-of-contents item with a heading candidate line independently, and (b) a second sum obtained by summing up bigram scores b for all pairs of table-of-contents items, the bigram score b evaluating the likelihood of associations of paired table-of-contents items, which are a pair of one table-of-contents item and another table-of-contents item, with heading candidate lines on the basis of the degree of commonality between associations of the paired table-of-contents items with the heading candidate lines.

### BRIEF DESCRIPTION OF THE SEVERAL VIEWS OF THE DRAWINGS

In describing the various drawings, reference is made to accompanying drawings wherein like reference numerals designate like parts or steps and wherein:

FIG. 1 is a diagram showing an example of association between a table of contents and headings;

FIG. 2 is a diagram showing another example of association between a table of contents and headings;

FIG. 3 is a diagram showing an example of the functional configuration of an automatic association apparatus 300 according to an embodiment of the invention as claimed in the application concerned;

FIG. 4 is a diagram showing an example of a search target graph for searching for the maximum value of a score function S;

FIG. 5 is a diagram showing an example of the search target graph for which first filtering and second filtering have been performed;

FIG. 6 is a diagram showing an example of the search target graph added with edges indicating page missing;

FIG. 7 is a diagram showing an example of the search target graph added with nodes indicating page missing;

FIG. 8 is a flowchart showing an example (example 1) of the flow of the whole process by the automatic association apparatus 300;

FIG. 9 is a flowchart showing an example of the flow of a Directed Acyclic Graph (“DAG”) node creation process;

FIG. 10 is a flowchart showing an example of the flow of a DAG edge creation process;

FIG. 11 is a flowchart showing an example of the flow of a process of searching for the maximum value of the score function S;

FIG. 12 is a flowchart showing an example of the flow of a process of outputting associations M which give the maximum value of the score function S;

FIG. 13(a) is a diagram showing an example of a table of contents having a tree structure, and FIG. 13(b) is a diagram showing an example of the order of restoring an array of associations M;

FIG. 14 is a flowchart showing an example (example 2) of the flow of the whole process by the automatic association apparatus 300;

FIG. 15 is a flowchart showing an example of the flow of a heading candidate line decision process;

FIG. 16 is a flowchart showing an example of the flow of a recursive function comp(c, l, r) calculation process;

FIG. 17 is a flowchart showing an example of the flow of a recursive function INCOMP(c, l, r) calculation process;

FIG. 18 is a flowchart showing an example of the flow of a recursive function getcomp(c, l, r) process;

FIG. 19 is a flowchart showing an example of the flow of a recursive function GETINCOMP(c, l, r) process; and

FIG. 20 is a diagram showing an example of the hardware configuration of an information processing apparatus suitable for realizing the automatic association apparatus 300 according to the embodiment of the invention as claimed in the application concerned.

### DETAILED DESCRIPTION

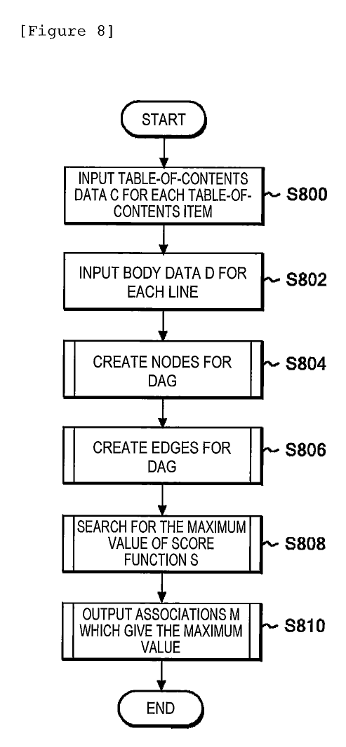

The best mode for carrying out the invention as claimed in the application concerned will be described below in detail on the basis of drawings. However, an embodiment described below do not limit the invention to claims, and all the combinations of the characteristics described in the embodiments are not necessarily indispensable for solution means of the invention. The same components are given the same reference numerals through the whole description of the embodiment. Further by way of prefatory comment, in the following description, function names often appear in upper case, whereas in the various figures they appear in lower case. No distinction is intended; the use of upper case herein for function names is intended to identify them more readily from expository text. In expressing equations or process steps, however, functions often appear in lower case because the reader skilled in the art will readily recognize these as functions without the benefit of upper case printing. Additionally, in several of the flowcharts of the figures, processing steps are designated by the letter “S” followed by a numeral, for instance S800 in FIG. 8. In this written description, just the numeral is mentioned, viz, “800,” it being understood that this corresponds to the item or step in the drawing with that same reference numeral preceded by “S.”

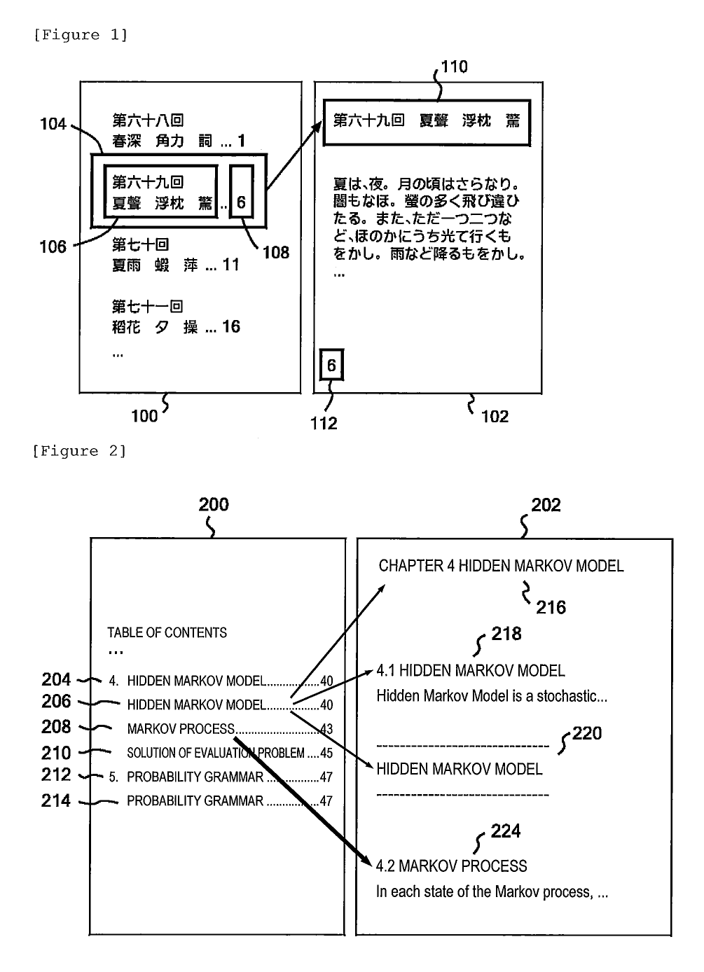

FIG. 1 is a diagram showing an example of association between a table of contents and headings. In FIG. 1, the left side indicates a table-of-contents page 100, and the right side indicates a body page 102. On the table-of-contents page 100, table-of-contents items are lined up, and each of the table-of-contents items is constituted by a character string having an index part (in the example of a table-of-contents item 104, a character string 106 beginning with “The 69th”) and a page number (in the example of the table-of-contents item 104, the numeral 108 indicating “6”). The body page 102 includes a heading 110 corresponding to a table-of-contents item, and a page number 112 indicating “6” at the lower left of the page.

The subject matter disclosed herein automatically associates each table-of-contents item in the table-of-contents page 100 with a corresponding heading line in a body page appropriately by arithmetic processing by a computer, as indicated by an arrow shown in FIG. 1. One of criteria that are effective for evaluating the likelihood of association of a table-of-contents item with a heading line is the degree of similarity between the character strings of the table-of-contents item and the heading line.

However, it is expected that table-of-contents data and body data obtained by OCR processing includes noise (misspellings, omitted letters and garbled characters). Furthermore, though the character string of a table-of-contents item includes an index part in the example shown in FIG. 1, such an index part is sometimes given only to a heading line. In such a case, if the same character string as that of a table-of-contents item is included in a body at multiple positions, it is not possible to correctly evaluate the likelihood of association only by the degree of similarity between character strings.

FIG. 2 provides an example of the case described above. Similar to FIG. 1, the left side indicates a table-of-contents page 200, and the right side indicates a body page 202. Though a chapter number is given to all heading lines 216, 218 and 224 in the body page 202, only a main chapter number is given to corresponding table-of-contents items 204 and 212 in the table-of-contents page 200. Therefore, it is not possible to judge which one of three candidates (the line 216 of “Chapter 4 Hidden Markov Model” in the body page 202, the line 218 of “4.1 Hidden Markov Model,” and the line 220 of “Hidden Markov Model” a table-of-contents item 206 of “Hidden Markov Model”) is to be associated with, only from the degree of similarity between character strings. In this regard, it may be observed that in FIG. 2, three arrows (unnumbered) point from the left side entry 206 to the three right side entries 216, 218, and 220.

The disclosed subject matter uses the fact that headings have a common characteristic as a heading. It evaluates the degree of commonality between an association of one table-of-contents item with a line as a heading candidate (hereinafter referred to as a “heading candidate line”) and an association of another table-of-contents item with a heading candidate line. This will be described with the case in FIG. 2 described above as an example.

As for the table-of-contents item 206 of “Hidden Markov Model”, the three lines of the line 216 of “Chapter 4 Hidden Markov Model”, the line 218 of “4.1 Hidden Markov Model” and the line 220 of “Hidden Markov Model” in the body page 202 are extracted as heading candidate lines on the basis of the degree of similarity between the character strings of the table-of-contents item and the heading candidate lines, as described above. Here, association of the table-of-contents item 206 with the heading candidate lines will be further examined on the basis of the degree of commonality with association of the adjacent table-of-contents item 208 of “Markov Process” with the line 224 of “4.2 Markov Process” which is a heading candidate line. Then, the line 218 of “4.1 Hidden Markov Model” can be correctly selected on the basis of the height (amount) of commonality between the index parts of the associated heading candidate lines.

That another table-of-contents item to be selected at the time of evaluating the degree of commonality between associations differs depending on whether the table of contents has a tree structure or not. In the case of a table of contents which does not have a tree structure but has a flat structure, the formats of headings associated with table-of-contents items are thought to be the same. Therefore, if all table-of-contents items are at the same level, that another table-of-contents item may be any table-of-contents item that is different from said one table-of-contents item, and, in the evaluation of the commonality degree, the higher the commonality degree is, the higher the evaluation is. However, it is desirable for that another table-of-contents item to differ for each table-of-contents item. Therefore, in the embodiment described below, that another table-of-contents item is assumed to be a table-of-contents item adjacent to said one table-of-contents item.

On the other hand, in the case of a table of contents having a tree structure, the formats of headings associated with paired table-of-contents items in a sibling relationship, respectively, are thought to be the same. However, the formats of headings associated with paired table-of-contents items in a parent-child relationship are thought not to be the same but to be in a large-small relationship in font size, chapter number or the like. Therefore, in the case of a table of contents having a tree structure, that another table-of-contents item to be selected is a table-of-contents item in a sibling relationship with said one table-of-contents item, and, in the evaluation of the commonality degree, the higher the commonality degree is, the higher the evaluation is. However, if the commonality degree is evaluated so that evaluation is higher as the commonality degree is lower, it is also possible to select a table-of-contents item in a parent-child relationship with said one table-of-contents item as that another table-of-contents item.

Furthermore, it is possible to use page information in a table of contents by evaluating the commonality degree between association of one table-of-contents item with a heading candidate line and association of another table-of-contents item with a heading candidate line. This is because, even if there is difference between the page numbers included in table-of-contents items in a table of contents and actual page numbers, that is, sequential numbers from the first page of the document, the degree of the difference is the same in all associations. It should be noted that evaluation of association based on the degree of commonality between differences, the difference being obtained by subtracting the page number of a table-of-contents item from the sequential number, can be applied to any pair of table-of-contents items irrespective of whether the table of contents has a tree structure or not.

Hereinafter, the problem of association between a table-of-contents item and a heading candidate line will be formulated and used for explanation.

Input data to an apparatus for automatic association between a table of contents and headings includes table-of-contents data C and body data D, defined as follows:

C={(s₁, p₁), . . . ,(s_{|C|},p_{|C|})}— (Definition 1)

Here, |C| denotes the number of all table-of-contents items included in a table of contents; sᵢ denotes the character string of the i-th table-of-contents item; and pᵢ denotes the page number of the i-th table-of-contents item. Also:

D={L₁, . . . ,L_{|D|}}— (Definition 2)

Here, |D| denotes the number of all lines included in a body, and Lₖ denotes the k-th line included in the body.

Such table-of-contents data C may be acquired by presuming a table-of-contents page from scan data of a document and using each line as table-of-contents data. In this case, the numeral at the end of each line can be set as the page number pᵢ, and the remainder except blank characters at both ends can be set as the character string sᵢ of the table-of-contents item. For the details of such processing, see, for example, S. Mandal, S. P. Chowdhury, A. K. Das, and B. Chanda, “Automated Detection and Segmentation of Table of Contents Page from Document Images” in Proceedings of ICDAR 2003.

The table-of-contents data C is often possessed by a publishing company that is the owner of the book. When that is the case, the table-of-contents data C can be acquired from the publishing company.

On the other hand, each line Lₖ included in the body is assumed to be constituted by a character string and additional information such as a sequential number and a font size. In general, an OCR outputs not only information about a recognized character but also information about a rectangle occupied by the character. Specifically, the information includes positional coordinates (x, y) of the rectangle in a page with the corner of the page as the origin, the width and height of the rectangle (“width” and “height”). A common OCR can recognize a line by performing processing such as connecting characters adjacent to each other below a threshold as being on the same line and output a scan result of each character for each line. Therefore, in this embodiment, this function of the OCR is used to acquire the character string (not including blank characters) of each line Lₖ from a set of recognition results of characters recognized to be on the same line, determine the median of the height (“height”) and set it as the font size of each line Lₖ. Furthermore, since the OCR performs scanning sequentially from the top toward the bottom of each page in the case of lateral writing, it can acquire a sequential number or a line number in a page (in the case of longitudinal writing, a sequential number and a column number in a page). In this embodiment, it is assumed that the sequential number and the line number in a page are given to each line Lₖ.

Next, as output from the apparatus for automatic association between a table of content and headings, output data M is defined as follows:

M={mᵢ. . .,m_{|C|}}— (Definition 3)

Here, |C| denotes the number of all table-of-contents items included in a table of contents. The output data M is a row of positive integers indicating which line each table-of-contents item corresponds to, and an element mᵢ denotes that the i-th table-of-contents item corresponds to the mᵢ-th line (mᵢ=positive integer value). Therefore, hereinafter, the output data M will be also referred to as associations M.

Here, a score function S will be considered which indicates the likelihood of the associations M of all the table-of-contents items in the table-of-contents data C with heading candidate lines in the body data D and which is a function of C, D, and M. Then, the problem of association of a table-of-contents item with a heading candidate line can be formulated as a problem of determining the associations M which maximize the score function S.

Preferably the likelihood of association of a table-of-contents item with a heading candidate line is evaluated not only by evaluating the association independently but also by taking account of the degree of commonality with association of another table-of-contents item with a heading candidate line, as described above. Therefore, the score function S described above is preferably defined as follows:

S(C,D,M)=Σᵢu(i,mᵢ,C,D)+Σᵢb(i,mᵢ,C,D)— (Definition 4)

Here, u denotes a unigram score which evaluates the likelihood of association of each table-of-contents item with a heading candidate line independently and denotes the score of each element mᵢ of the output data M. Also, b denotes a bigram score which evaluates the likelihood of association of paired table-of-contents items, which are a pair of one table-of-contents item and another table-of-contents item, with heading candidate lines, on the basis of the degree of commonality between associations of the paired table-of-contents items with their heading candidate lines and denotes the score of each pair mᵢ, mⱼ which is an element of the output data

M.

Since there are an exponential number of candidates for the associations M, for an input length, it is generally difficult to enumerate all associations M to determine the maximum value of the score function S from the viewpoint of the amount of calculation. However, by expressing the score function S as the total of a first sum obtained by summing up unigram scores u for all the table-of-contents items and a second sum obtained by summing up bigram scores b for all the pairs of table-of-contents as described above, it is possible to calculate the score function S in a polynominal time. For example, it is known that, by applying the Viterbi algorithm, the series of associations M which maximize the score function S described above can be determined as time complexity O(|C∥D|²) for the number of table-of-contents items |C| and the number of lines in a body |D|. By filtering elements of the body data D, that is, heading candidate lines, the time complexity can be further reduced.

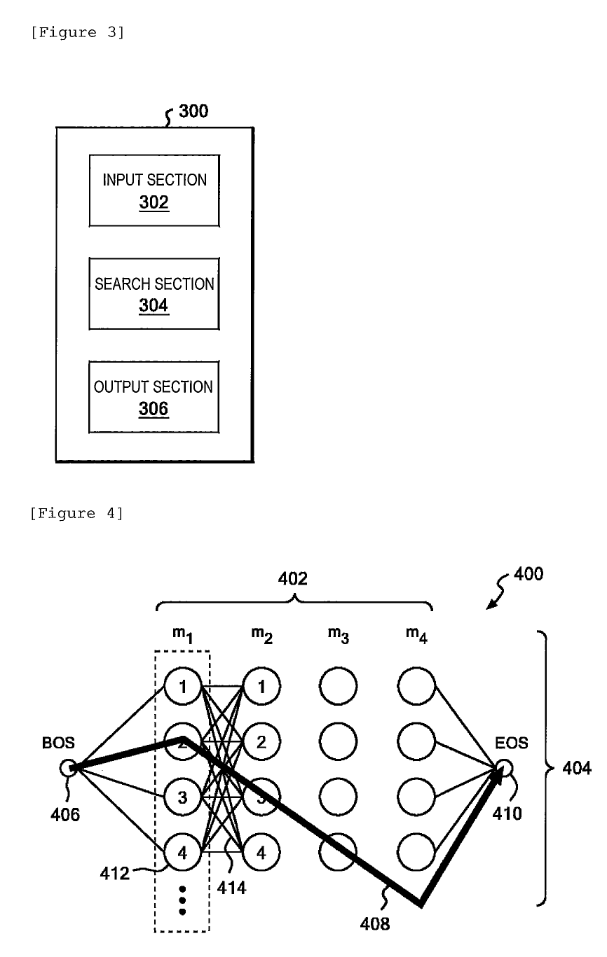

Turning to FIG. 3, an illustrative embodiment apparatus 300 for automatic association between table of contents and headings is described. FIG. 3 is a diagram showing the functional configuration of the apparatus 300 which includes an input section 302, a search section 304, and an output section 306.

The input section 302 reads table-of-contents data C of each table-of-contents item of a document and body data D of each line of the document, from a storage device or from another computer via a network and inputs them. The search section 304 searches for the maximum value of a score function S which indicates the likelihood of associations M of all table-of-contents items in the table-of-contents data C with heading candidate lines in the body data D and which is a function of C, D, and M. The output section 306 outputs the associations M which maximize the score function S.

Here, the search section 304 determines the score function S as the total of the first sum obtained by summing up unigram scores u for all the table-of-contents items, which has been described with regard to Definition 4, and a second sum obtained by summing up bigram scores b for all pairs of table-of-contents items, which has been similarly described with regard to Definition 4.

As for the bigram score b, the way of making a pair of table-of-contents items for which the value of the bigram score b is to be determined differs depending on whether the table of contents has a tree structure or not, as described above. Therefore, the case where the table of contents has a flat structure and the case where the table of contents has a tree structure will be sequentially described as an Example 1 and an Example 2, respectively, below.

### EXAMPLE 1

In Example 1, it is assumed that a table of contents has a flat structure, and all table-of-contents items are at the same level. In this case, a pair of table-of-contents items for which the bigram score b is to be determined may be any pair of table-of-contents items. As for evaluation of the commonality degree, the higher the commonality degree is, the higher the evaluation is. However, it is desirable that another table-of-contents item to be paired with one table-of-contents item differs for each table-of-contents item. Therefore, in this example, it is assumed that the pair of table-of-contents items is a pair of table-of-contents items adjacent to each other, and Definition 4 is rewritten as follows:

S(C,D,M)=Σᵢu(i,mᵢ,C,D)+Σᵢb(i,mᵢ, mᵢ₊₁,C,D)— (Definition 5)

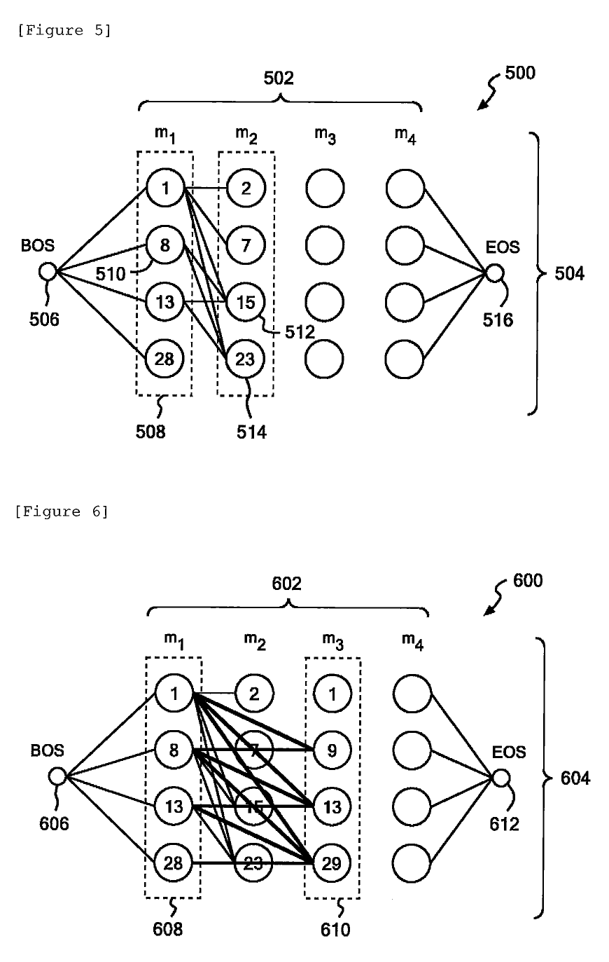

First, a method for designing the unigram score u and the bigram score b in Definition 5 will be described below. After that, a method for searching for the maximum value of the score function S expressed by Definition 5 will be described with reference to FIGS. 4 to 7.

As already described, the unigram score u(i, mᵢ, C, D) is a score evaluating the likelihood of association of the i-th table-of-contents item (C[i]) with the m₁-th line (D[mᵢ]) of a document independently. The unigram score u(i, mᵢ, C, D) will be also referred to simply as u(i, mᵢ) below. A first example of the independent evaluation is evaluation based on the degree of similarity between character strings. That is, the unigram score u is designed so that a high score is returned if the character string of C[i] and the character string of D[mᵢ] are similar to each other.

As an example of the judgment about whether character strings are similar or not, the editing distance between the character strings of C[i] and D[mᵢ] or the number of pairs of two characters adjacent to each other which are included in the character strings of C[i] and D[mᵢ] in common may be used. The former editing distance is a numerical value indicating how much two character strings are different from each other. Therefore, if the editing distance is equal to or below a predetermined threshold, similarity can be judged. In the latter case, a set of pairs of two characters adjacent to each other is determined for each of character strings. If the size of a product set of the two sets is equal to or above a predetermined threshold, similarity can be judged. Hereinafter, the predetermined threshold at the time of judging whether similar or not will be referred to as MINSIM for convenience. For the details of the editing distance, see, for example, Gonzalo Navarro and Mathieu Raffinot, “Flexible Pattern Matching in Strings: Practical On-Line Search Algorithms for Texts and Biological Sequences”, Cambridge University Press, 2007.

A second example of the independent evaluation is evaluation based on the kind of line. That is, a unigram score u is designed which returns a high score if it can be judged that D[mᵢ] has characteristics of a heading, from information about font size, position and the like. On the contrary, a unigram score u is designed which returns a low score if it is judged that D[mᵢ] has characteristics of a main clause, notes and a body, from the information about font size, position and the like. Since multiple evaluations based on the kind of line are conceivable, the unigram score u may be designed so that a final score is outputted by combining multiple judgments, for example, in a manner that the score is increased by one if it is likely to be a heading, and is decreased by one if it is not likely to be a heading.

Here, whether the font size is large or small can be judged by comparison with a body other than a heading or notes. Therefore, the median of the font sizes of all the lines in the document is substituted for the font size of the body, and a judgment of being a heading can be made if D[mᵢ] has a font size larger than the median, and a judgment of not being a heading can be made if D[mᵢ] has a font size smaller than the median. As for position information, a judgment of being a heading may be made, for example, if D[mᵢ] is the first line of a page, because a heading is often positioned at the beginning of a page. On the contrary, if D[mᵢ] is the last line of a page, a judgment of not being a heading may be made because the possibility of being notes is high in that case. A heading line has a tendency of being different from a body, for example, being positioned at the center of a page or projecting to the left from the body. Therefore, for example, in the case of lateral writing, it is possible to make a judgment of being a heading if the absolute value of a value obtained by subtracting the character start position of D[mᵢ] from the median of the character start positions of all lines is equal to or larger than a predetermined threshold and, otherwise, make a judgment of not being a heading. It should be noted that the above description is only examples of the judgment based on position information and do not limit the use of knowledge about other characteristics of a heading with regard to position information.

The unigram score u may be made from an evaluation only on the basis of the degree of similarity between character strings described above or may be made from a comprehensive evaluation by summing up the evaluation (score) based on the degree of similarity between character strings and the evaluation (score) based on the kind of line, adding a weight appropriately. In the case of adopting such comprehensive evaluation, it is sufficient to determine any one evaluation (score) even if all the evaluations (scores) cannot be acquired because, for some of associations, font size or position information cannot be acquired. As for weighting, a weight for each score may be automatically learned from correct data.

Next, a method for designing the bigram score b((i, mᵢ, mᵢ₊₁, C, D) will be described. As already described, the bigram score b(i, mᵢ, mᵢ₊₁, C, D) is a score evaluating the likelihood of associations of paired table-of-contents items, which are a pair of one table-of-contents item (the i-th table-of-contents item (C[i])) and another table-of-contents item (the (i+1)th table-of-contents item (C[i+1])) adjacent to said one table-of-contents item, with heading candidate lines (the mᵢ-th line (D[mᵢ]) and the (mᵢ₊₁)th line (D[mᵢ₊₁])) on the basis of the degree of commonality between the associations of the paired table-of-contents items adjacent to each other with their heading candidate lines. As described above, the evaluation of the commonality degree in Example 1 is evaluation in which a higher evaluation is given as the commonality degree is higher. Hereinafter, the bigram score b(i, mᵢ, mᵢ₊₁, C, D) will be also referred to simply as b(i, i+1, mᵢ, mᵢ₊₁).

A first example of the evaluation based on the commonality degree is evaluation based on the degree of commonality between formats. That is, the bigram score b can be designed so that a high score is returned if the commonality between the formats of D[mᵢ] with which C[i] is associated and D[mᵢ₊₁] with which C[i+1] is associated is high. More specifically, the degree of commonality between formats can be the degree of commonality between the font sizes of D[mᵢ] and D[mᵢ₊₁], and the degree of commonality between the formats can be judged to be high if the font sizes of D[mᵢ] and D[mᵢ₊₁] can be regarded as the same. This is based on the knowledge that, in the case of a table of contents with a flat structure, the font sizes of headings are the same.

The degree of commonality between formats can be the degree of commonality between the first characters or the first and last characters of the character strings of D[mᵢ] and D[mᵢ₊₁]. That is, if the character strings of D[mᵢ] and D[mᵢ₊₁] start with a common character or start with a common character and end with a common character, the degree of commonality between the formats may be judged to be high. This is based on the knowledge that a heading often includes an index part (for example, “Chapter X”, “Section X” or the like) or a symbol indicating being a heading (for example, “§”, “⋄” or the like) at the top, that the symbol indicating being a heading is sometimes included at the top and end of a heading like “♦Realization of List♦”, and that such a format is common to all headings if a table of contents has a flat structure.

The degree of commonality between formats may be judged to be high if the degree of similarity between a predetermined number of characters before and after a character string part of D[mᵢ] similar to the character string of C[i] (hereinafter referred to as a similar character string of D[mᵢ]) and that of a character string part of D[mᵢ₊₁] similar to the character string of C[i+1] (hereinafter referred to as a similar character string of D[mᵢ₊₁]) is high. First, such judgment is effective when an index part or a symbol part is not included in the character string of a table-of-contents item. This is because, in this case, the predetermined number of characters before and after the similar character strings D[mᵢ] and D[mᵢ₊₁] indicate an index part (for example, “Chapter X”, “Section X” or the like) or a symbol part (for example, “§”, “♦” of “♦Realization of List♦”, or the like), and the degree of commonality between formats is judged to be high if the degree of similarity between these parts is high. Secondly, such judgment is effective at the time of using data other than scan data and without position information. This is because, in this case, the character string of a heading candidate line includes a blank character for format adjustment, and therefore, the predetermined number of characters before and the similar character strings of D[mᵢ] and D[mᵢ₊₁] indicate the blank character used for the format, so that the degree of commonality between formats is judged to be high if the degree of similarity between these parts is high.

A second example of the evaluation based on the commonality degree is evaluation based on the degree of commonality between differences, the difference being difference between a page number in a table of contents and an actual page number, that is, a sequential number beginning with the first page. That is, the bigram score b can be designed so that a high score is returned if the commonality between the difference between a page number included in C[i] and the sequential number of a page which includes D[mᵢ] associated with C[i] and the difference between a page number included in C[i+1] and the sequential number of a page which includes D[mᵢ₊₁] associated with C[i+1] is high. As an example, the degree of commonality between the differences may be judged to be high if the differences are the same.

This evaluation is based on the knowledge that though a page number in a table of contents and a sequential number are often different from each other due to existence of pages other than a body, such as a preface, the difference is constant. For example, suppose that the page numbers of table-of-contents items included in a table of contents are 1, 4, 11, 7 (wrong), 22 and 26, respectively. It is assumed that the page number of 7 is a wrong page number due to misreading. In comparison, it is assumed that the sequential numbers of corresponding heading candidate lines are 2, 5, 12, 18, 23 and 27. Then, the differences are 1, 1, 1, 11, 1 and 1, and the values of difference are the same for three of the five pairs of table-of-contents items adjacent to each other. By evaluating page numbers on the basis of differences, it is possible to prevent the evaluation from being influenced by a slight error of misreading of a page number.

In addition to the evaluation based on the degree of commonality between differences, the bigram score b may be designed so as to be in accordance with a non-adjacent line restriction. Here, the non-adjacent line restriction is a restriction that heading candidate lines D[mᵢ] and D[mᵢ₊₁] associated respectively with paired table-of-contents items C[i] and C[i+1] adjacent to each other should not be on lines adjacent to each other. This restriction is based on the knowledge that there is necessarily a body between successive headings. Therefore, the bigram score b may be designed so that its value is decreased if C[i] and C[i+1] are on lines adjacent to each other.

The bigram score b may be such that evaluation is performed by combining any number of evaluations (scores), among the three of the evaluation (score) based on the degree of commonality between formats, the evaluation (score) based on the degree of commonality between differences between pages and the evaluation (score) based on the non-adjacent line restriction described above, while weight is added. In the case of summing up multiple evaluations (scores) to perform evaluation, even if all the evaluations (scores) cannot be acquired because, for some of associations, font size or page information cannot be acquired, it does not matter if any one of the evaluations (scores) can be determined. In the weighting, the weight of each score may be automatically learned from correct data.

Turning next to FIG. 4, a method for searching for the maximum value of the score function S expressed by Definition 5 will be described. FIG. 4 shows a search target graph 400 for searching for the maximum value of the score function S. The graph 400 is constituted by nodes indicated by circles, the number of which corresponds to (the number of table-of-contents items (|C|) 402×the number of all lines in body (|D|) 404), a BOS 406 which is a virtual node indicating a search start point, an EOS 410 which is a virtual node indicating a search end point, and edges connecting adjacent nodes. It should be noted that, in FIG. 4, only a part of edges are shown, and the remaining edges are omitted.

Each node in the graph 400 indicates association about which table-of-contents item is associated with which line, by the column number of a column to which the node belongs and a number given to the node. For example, since a node 412 belongs to the first column and is given a number 4, it indicates association of the first table-of-contents item with the fourth line. Therefore, a set of nodes belonging to the i-th column can be regarded as a set of all associations that can be indicated by the element mᵢ of the associations M. It should be noted that, in FIG. 4, an associated line number is displayed in the circles of a part of the nodes, and such a line number is not displayed for the remaining nodes.

Each edge in the graph 400 indicates a pair of associations indicated by nodes at both ends of the edge, that is, associations of paired table-of-contents items which are adjacent to each other. For example, an edge 414 indicates a pair of association of the first table-of-contents item with the third line and association of the second table-of-contents item adjacent to the first table-of-contents item with the fourth line.

Each node is given a unigram score u for association indicated by the node. Each edge is given a bigram score b for associations of paired table-of-contents items adjacent to each other indicated by the edge. If such a graph 400 is given, search for the maximum value of the score function S can be grasped as a problem of selecting, from among all routes with the BOS 406 as a start point and the EOS 410 as an end point (a route 408 is an example), such a route that maximizes the total of scores given to nodes and edges included therein.

Since the graph 400 is a directed acyclic graph (DAG), this route search problem can be solved by the Viterbi algorithm or the Dijkstra method in a polynominal time for the number of nodes. Specifically, for the number of table-of-contents items |C| and the number of lines in body |D|, the time complexity 0(|C∥D|²) can be determined. Therefore, the actual calculation time can be further reduced by filtering the elements of the body data D, that is, heading candidate lines.

So, filtering of heading candidate lines will be described next. First filtering is filtering based on a page number restriction. A table of contents is such that headings are written in an orderly sequence. Therefore, the line number mᵢ of a heading line associated with a table-of-contents item C[i] has to be larger as i increases. Therefore, in the graph 400 shown in FIG. 4, such an edge that satisfies mᵢ>mᵢ₊₁ can be deleted. A node isolated by the deletion of an edge also can be deleted.

Second filtering is filtering based on the degree of similarity between the character strings of a table-of-contents item and a heading candidate line associated with the table-of-contents item. That is, the heading candidate line D[mᵢ] associated with the table-of-contents item C[i] can be limited to lines having a certain or higher degree of similarity to the character string of C[i] among all the lines in the body data D. Here, as for judgment of the similarity degree, a method similar to the method for the judgment of the similarity degree in the case of the unigram score u described above can be used.

FIG. 5 shows a graph 500 which is a result of deleting edges and nodes by the first filtering and the second filtering in the graph 400 shown in FIG. 4. However, it should be noted that, in FIG. 5, the line numbers of nodes and edges are omitted except for the columns for m₁ and m₂. As for a column 508 for m₁, line numbers given to nodes are non-consecutive values of 1, 8, 13, 28, . . . . This is the result of heading candidate lines to be associated with the first table of contents C[1] having been limited by the second filtering. For example, looking at a node 510, there are drawn only edges to nodes 512 and 514 which have line numbers 15 and 23 larger than the line number 8 of the node, respectively. This is the result of edges satisfying mᵢ>mᵢ₊₁ having been deleted by the first filtering. Thus, by deleting edges or nodes by filtering, the calculation time can be reduced.

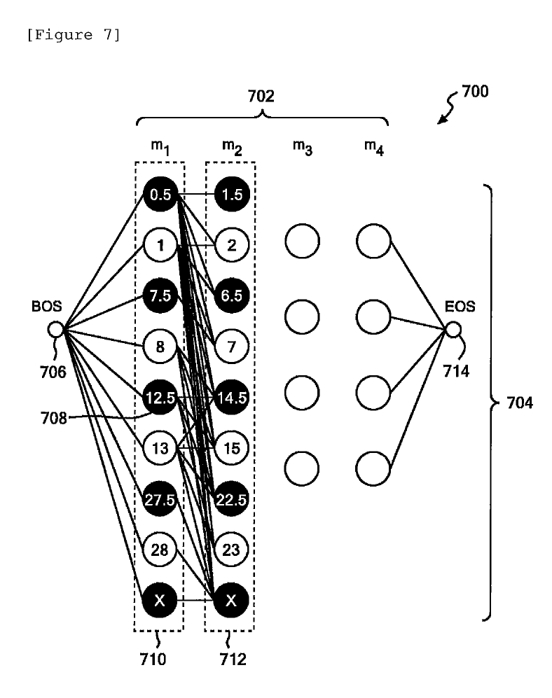

Since the body data D is acquired by OCR processing, there is a possibility of page missing. Therefore, in this embodiment, two methods described below with reference to FIGS. 6 and 7 are used to cope with the page missing.

A first method for coping with page missing is a method of adding an edge indicating page missing. In order to show associations of paired table-of-contents items adjacent to each other by an edge, the edge must be drawn only between the nodes adjacent to each other. However, by allowing an edge to be drawn with a predetermined number (this numerical value is hereinafter referred to as MAXSKIP for convenience) of or fewer nodes positioned between the nodes adjacent to each other, it is possible to cope with page missing. This will be described with reference to a graph shown in FIG. 6.

In FIG. 6, edges are added by allowing an edge to be drawn with one node positioned between nodes at both ends in the graph 500 after filtering shown in FIG. 5. However, it should be noted that, in FIG. 6, the line numbers of nodes and edges are omitted except for columns from a column 608 for mᵢ to a column 610 for m₃. In FIG. 6, multiple edges are added which connect nodes in the column 608 for m₁ and nodes in column 610 for m₃. Each of these newly added edges indicates that there is not a heading candidate line to be associated with the second table-of-contents item. Therefore, if a route which maximizes the total of scores includes the newly added edge, it is indicated that a page which includes a heading candidate line to be associated with the second table-of-contents item is missing. It should be noted that the first filtering can be applied to the newly added edge, and the bigram score b is given thereto.

A second method for coping with page missing is a method of adding a node indicating page missing. As for this node indicating page missing, one such node is added to each of all the nodes to distinguish the number of lines of the missing page. Then, a line number corresponding to the line number of a node immediately after the node minus 0.5 is given to the added node. This indicates that the node should exist between the lines immediately before and after the node but cannot be recognized, or the node does not exist due to page missing. As a unigram score for each node, a low or negative score is given indicating the penalty for page missing. This is for the purpose of making it difficult to judge page missing. Since the degree of similarity between formats between headings adjacent to each other cannot be measured, the bigram score b is set to 0.

In FIG. 7, one node is added to each of all the nodes in the graph 500 after filtering shown in FIG. 5. In a graph 700 in FIG. 7, the added nodes are indicated by black circles. However, it should be noted that, in FIG. 7, the line numbers of nodes, edges and the added nodes are omitted except for the columns for m₁ and m₂. Here, for example, a node 708 indicates that, though there should be a corresponding line between the twelfth and thirteenth lines, such a line could not been found. Therefore, if a route which maximizes the total of scores includes the newly added node 708, it is indicated that a page which includes a heading candidate line to be associated with the first table-of-contents item is missing. The first filtering can also be applied to an edge connecting the newly added node.

FIGS. 8 to 12 are used in describing the flow of processing by the apparatus for automatic association between table of contents and headings 300 according to Example 1 Preferably the Viterbi algorithm is used to search for the maximum value of the score function S.

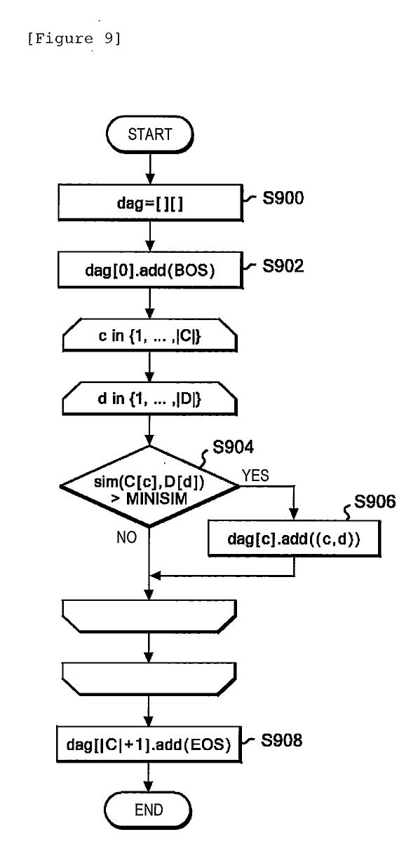

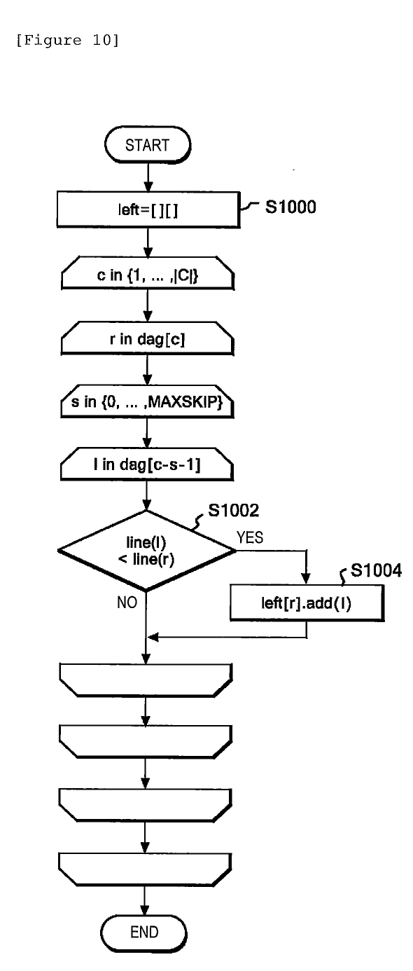

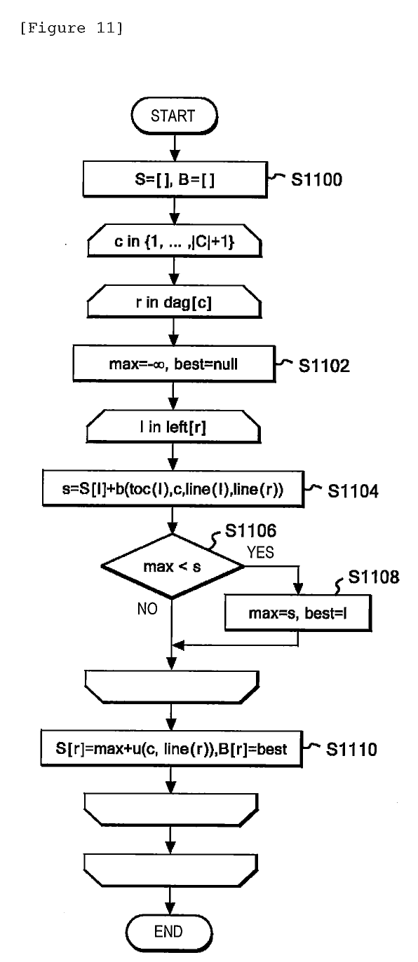

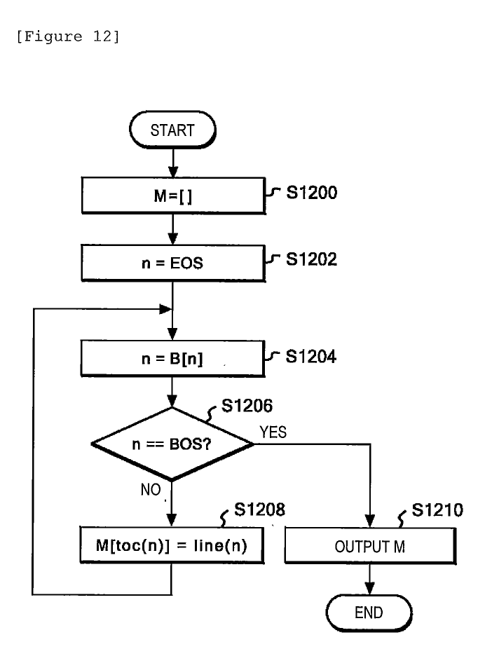

FIG. 8 is a flowchart showing an example of the flow of the illustrative process by the automatic association apparatus 300. FIG. 9 is a flowchart showing an example of the flow of a DAG (Directed Acyclic Graph) node creation process at step 804 of the flowchart shown in FIG. 8. FIG. 10 is a flowchart showing an example of the flow of a DAG edge creation process at step 806 of the flowchart shown in FIG. 8. FIG. 11 is a flowchart showing an example of the flow of a process of searching for the maximum value of the score function S at step 808 of the flowchart shown in FIG. 8. FIG. 12 is a flowchart showing an example of the flow of a process of outputting associations M which give the maximum value of the score function S at step 810 of the flowchart shown in FIG. 8.

First, the flow of an illustrative process of automatic association between a table of contents and a heading will be described with reference to FIG. 8. The process of automatic association shown in FIG. 8 starts at step 800, and the automatic association apparatus 300 inputs table-of-contents data C for each table-of-contents item and body data D for each line from a storage device or from another computer via a network (steps 800 and 802). Subsequently, the automatic association apparatus 300 uses the inputted table-of-contents data C and body data D to create nodes of a graph (hereinafter referred to as a DAG) for searching for the maximum value of the score function S(C, D, M) expressed by Definition 5 which has been described with reference to FIGS. 4 and 5 (step 804). The details of the node creation process will be described with reference to FIG. 9.

Subsequently, the automatic association apparatus 300 creates edges of the DAG on the basis of information about the nodes of the DAG which have been created at the previous step (step 806). The details of the edge creation process will be described with reference to FIG. 10. Subsequently, the automatic association apparatus 300 uses the created DAG to search for the maximum value of the score function S(C, D, M) (step 808). The details of the search process will be described with reference to FIG. 11. Lastly, the automatic association apparatus 300 outputs associations M which give the maximum value of the score function S(C, D, M) determined at step 808. The details of the process of outputting the associations M will be described with reference to FIG. 12. Then, the process ends.

Next, the details of the DAG node creation process will be described with reference to FIG. 9. Here, the second filtering based on the degree of similarity between character strings described above is adopted. The DAG node creation process shown in FIG. 9 starts at step 900, and the automatic association apparatus 300 prepares a two-dimensional array dag indicating node information about the DAG first. Setting of a value for each element of the two-dimensional array dag is performed in the subsequent process. It is assumed that an element r of the two-dimensional array dag is of an abstract data type indicating a node, and that the element indicates association of the toc(r)th table-of-contents item with a heading candidate line with the line number of line(r). However, a function TOC and a function LINE are assumed to be functions which return the number of a table-of-contents item targeted by association and the line number of a heading candidate line, respectively, to the element r. For the c-th table-of-contents item, DAG[c] is assumed to indicate an array of nodes corresponding to the c-th table-of-contents item. (In the figures, these functions are generally in lower case letters.)

When having prepared the two-dimensional array dag, the automatic association apparatus 300 subsequently adds a virtual node BOS indicating a search start point, to an element dag[0] of a two-dimensional array dag (step 902). Both of the functions TOC and LINE are assumed to return 0 to the virtual node BOS. Subsequently, the automatic association apparatus 300 repeats the processing of step 904 and, if applicable, the processing of step 906 by a first loop and a second loop. The first loop is a loop which repeats while incrementing a variable c by 1 from 1 to the number of table-of-contents items |C|. The second loop is a loop which repeats while incrementing a variable d by 1 from 1 to the number of all lines in a body |D| relative to the value of the variable c.

At step 904, the automatic association apparatus 300 judges whether the degree of similarity between the character string of the c-th table-of-contents item C[c] and the character string of the d-th line D[d] is above the minimum acceptable similarity degree MINSIM or not. As already described, an existing technique such as the editing distance can be used for the judgment of the similarity degree. If the similarity degree is above MINSIM (step 904: YES), then the automatic association apparatus 300 adds a node indicating association (c, d) of the c-th table-of-contents item to the d-th line, to DAG[c] (step 906). If the similarity degree is equal to or below MINSIM (step 904: NO) or after the processing of step 906, the automatic association apparatus 300 repeats the series of processings until it exits all the first and second loops.

When the above repeating process ends, the automatic association apparatus 300 adds a virtual node EOS indicating a search end point, to a two-dimensional DAG[|D|+1] (step 908). The functions TOC and LINE return |C|+1 and |D|+1 to the virtual node EOS, respectively. Then, the process ends.

Next, the details of the DAG edge creation process will be described with reference to FIG. 10. Here, the first filtering based on the page number restriction described above is adopted. In order to cope with page missing, the first method described above, that is, the method of adding an edge indicating page missing is also adopted. The DAG edge creation process shown in FIG. 10 starts at step 1000, and the automatic association apparatus 300 prepares a two-dimensional array left indicating edge information about the DAG. Setting of a value for each element of the two-dimensional array left is performed in the subsequent process. For each element n of the two-dimensional array dag, a two dimensional array left[n] indicates an array of nodes existing in a column on the immediate left (a side of the virtual node BOS) of the column of nodes indicated by the element n (hereinafter referred to simply as a node n) and from which an edge is to be drawn to the node n.

When having prepared the two-dimensional array left, the automatic association apparatus 300 repeats the processing of step 1004 and, if applicable, the processing of step 1006 by four nested loops. A first loop is a loop which repeats while incrementing a variable c by 1 from 1 to the number of table-of-contents items |C|. A second loop is a loop which repeats while sequentially taking out one node r from an array of nodes indicated by DAG[c] for each value of the variable c. A third loop is a loop which repeats while incrementing a variable s for each node r from 0 to the maximum acceptable number of page missings MAXSKIP. A fourth loop is a loop which repeats while sequentially taking out one node 1 from an array of nodes indicated by DAG[c-s-1] for each of the values of the variables c and s.

At step 1002, the automatic association apparatus 300 judges whether the value of the line number line(r) of the node r is larger than the value of the line number line(l) of the node 1 or not. If line(r)>line(l) is satisfied (step 1002: YES), the automatic association apparatus 300 adds the node 1 to left[r] (step 1004). If line(r)line(l) is satisfied (step 1002: NO) or after the processing of step 1006, the automatic association apparatus 300 repeats the series of processings until it exits all of the four loops. Then, the process ends.

Next, the details of the process of searching for the maximum value of the score function S will be described with reference to FIG. 11. The process of searching for the maximum value of the score function S shown in FIG. 11 starts at step 1100, and the automatic association apparatus 300 prepares arrays S and B each of which has the number of elements corresponding to the number of generated DAG nodes. Setting of a value for each element of the arrays S and B is performed in the subsequent process. It is assumed that S[n] stores the maximum score among the scores of routes with the virtual node BOS and the node n as the start point and the end point, respectively. Here, the score of a route is the total of the unigram scores u and the bigram scores b which are given to nodes and edges included in the route. It is assumed that B[n] stores information about the last edge (information about a node immediately before the node n) included in the route which is given the maximum score set for S[n]. The zeroth element S[0] of the array S is initialized with null.

As already described, the unigram score u given to the node r is a unigram score u(TOC(r), LINE(r)) of association indicated by the node r. The bigram score b given to an edge connecting the node r and the node 1 is a bigram score b (TOC(r), TOC(l), LINE(r), LINE(l)) of associations of paired table-of-contents items adjacent to each other indicated by the edge. The unigram score u and the bigram score b given to each node and each edge may be determined in advance before the process of searching for the maximum value of the score function S or may be determined in steps 1104 and 1110 below as necessary.

When the array S is defined as described above, the maximum value of the score function S to be determined is determined as S[EOS]. The maximum score S[r] of a route with the virtual node BOS and the node r as the start point and the end point, respectively, can be determined by adding the unigram score u of the node r to the maximum value (hereinafter referred to as a partial maximum value) of a value obtained by adding the value S[l] of the array S for the node 1 immediately before the node r and the bigram score b of the edge connecting the node 1 and the node r. Therefore, in order to determine the value of S[EOS], it is necessary to determine the values of the arrays S and B for each of DAG nodes in the order from the virtual node BOS toward the virtual node EOS. The array B, which will be described in detail with reference to FIG. 12, is used to identify the route which is given the maximum value of the score function S.

The automatic association apparatus 300 repeats the process from step 1102 to step 1110 (though step 1008 is repeated only when applicable) by first and second loops in order to determine the values of the arrays S and B for each of the DAG nodes in the order from the virtual node BOS toward the virtual node EOS. The first loop is a loop which repeats while incrementing a variable c by 1 from 1 to the number of table-of-contents items plus 1 (|C|+1). The second loop is a loop which repeats while sequentially takings out one node r from an array of nodes indicated by dag[c] for each value of the variable c.

At step 1102, the automatic association apparatus 300 prepares a variable max for determining the above partial maximum value for the node r and initializes it with −∞. The automatic association apparatus 300 also prepares a variable best for holding information about the last edge at the time of setting the partial maximum value for the variable max and initializes it with null. Then, the automatic association apparatus repeats the subsequent process from step 1104 to step 1108 (though the processing of step 1108 is repeated only when applicable) by a third loop in order to determine the above partial maximum value for the node r. The third loop is a loop which repeats while sequentially taking out one node 1 from an array of nodes indicated by left[r] for each node r.

At step 1104, the automatic association apparatus 300 sets a value obtained by adding the bigram score b(toc(l), c, line(l), line(r)) given to the edge connecting the node 1 and the node r and S[l] to each other, for a temporary variable s. Subsequently, the automatic association apparatus 300 judges whether or not the temporary variable s is larger than the variable max (step 1106). If s>max is satisfied (step 1106: YES), the automatic association apparatus 300 sets the value of the temporary variable s for the variable max and the node I for the variable best (step 1108). If s≦max is satisfied (step 1106: NO) or after the processing of step 1108, the automatic association apparatus 300 repeats the series of processings until it exits the third loop.

When having exited the third loop, the automatic association apparatus 300 subsequently sets a value obtained by adding the variable max and the unigram score u(c, line(r)) to each other for S[r] and sets the value of the variable best for B[r] (step 1110). Subsequently, the automatic association apparatus 300 repeats the above series of processings until it exits the first loop. Then, the process ends.

Next, the details of the process of outputting associations M which give the maximum value of the score function S will be described with reference to FIG. 12. As described above, in each element B[n] of the array B determined in the process of searching for the maximum value of the score function S, which is shown in FIG. 11, there is stored information about the last edge (information about a node immediately before the node n) included in the route which is given the maximum score set for the array S[n]. The maximum value of the score function S is given by S[EOS]. Therefore, the associations M which give the maximum value of the score function S can be determined by sequentially connecting information about edges from B[EOS] to B[BOS], with B[EOS] as a start point. Therefore, at the start of the process, the automatic association apparatus 300 prepares an array of associations M described as Definition 3 first (step 1200).

Subsequently, the automatic association apparatus 300 sets a virtual node EOS indicating a search end point for a variable n indicating a node (step 1202). Subsequently, the automatic association apparatus 300 sets B[n] for n (step 1204). Subsequently, the automatic association apparatus 300 judges whether the current value of the variable n is equal to BOS or not (step 1206). If the value of the variable n is not equal to BOS (step 1206: NO), then the automatic association apparatus 300 proceeds to the processing of step 1208 and sets the value of line(n) for M[toc(n)]. After that, the automatic association apparatus 300 returns to the processing of step 1204.

On the other hand, if the value of the variable n is equal to BOS (step 1206: YES), then the automatic association apparatus 300 proceeds to the processing of step 1210 and outputs an array M. Then, the process ends.

### EXAMPLE 2

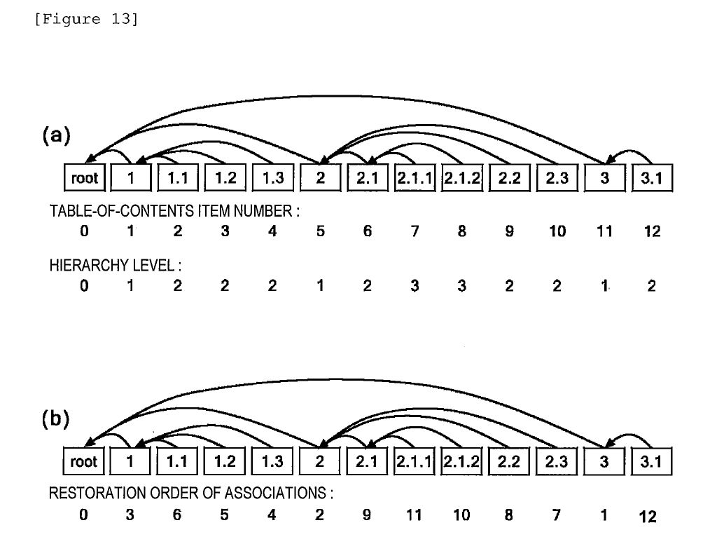

In Example 2, it is assumed that a table of contents has a tree structure. FIG. 13(a) shows an example of the table of contents having a tree structure. In FIG. 13(a), only index parts of the table of contents are shown by numerals in rectangles. Arrows in the figure indicate parent-child relationships between table-of-contents items. The numerals on the upper line displayed under the rectangles indicate table-of-contents item numbers, and the numerals on the lower line indicate hierarchy levels when the hierarchy level of the root is assumed to be 0.

For any pair of table-of-contents items in a sibling relationship that the arrow destinations are the same (for example, “1.1” and “1.2”), the hierarchy levels of the table-of-contents items are the same, and the format is common to the table-of-contents items. On the other hand, for any pair of table-of-contents items in a parent-child relationship of being an arrow source and an arrow destination (for example, “1” and “1.1”), the hierarchy layers of the table-of-contents items are different by one level, and the formats are also different between the table-of-contents items.

Thus, the formats of headings associated with paired table-of-contents items in a sibling relationship in the tree structure of a table of contents, respectively, are thought to be the same. On the other hand, the formats of headings associated with paired table-of-contents items in a parent-child relationship in the tree structure of a table of contents, respectively, are not the same and thought to be in a large-small relationship in font size, chapter number or the like. Therefore, if a table of contents has a tree structure, a pair of table-of-contents items for which the bigram score b should be determined is a pair of table-of-contents items in a sibling relationship of being adjacent to each other on the same hierarchy layer in the tree structure of the table of contents (hereinafter, referred to as a pair of table-of-contents items adjacent to each other which are in a sibling relationship), and, as for evaluation of the commonality degree, a higher evaluation is given as the commonality degree is higher. However, if the evaluation of the commonality degree is performed so that the evaluation is higher as the commonality degree is lower, it is possible to select a pair of table-of-contents items in a parent-child relationship. As an example, the data of the tree structure of the table of contents may be stored as a list of numerical values indicating the hierarchy levels of the tree structure arranged in the order of table-of-contents items and used.

Therefore, in Example 2, a sibling bigram score b1, which returns a higher score value as the degree of commonality between associations of paired table-of-contents items with their respective heading candidate lines is higher, is adopted as the bigram score b, for a pair of table-of-contents items adjacent to each other which are in a sibling relationship. For a pair of table-of-contents items in a parent-child relationship, a parent-child bigram score b2 which returns a higher score value as the degree of commonality between associations of paired table-of-contents items with their heading candidate lines is lower, is adopted as the bigram score b. Only one of the sibling bigram score b1 or the parent-child bigram score b2 can be adopted as the bigram score b.

Therefore, in Example 2, Definition 4 is rewritten as follows:

S(C,D,M)=Σᵢu(i,C,D)+Σᵢb1(i,mᵢ,m_{sib(i)},C,D)+Σᵢb2(i,mᵢ,mₚₐᵣ₍ᵢ₎,C,D)— (Definition 6)

Here, sib(i) is a function which returns the table-of-contents item number of an immediately previous elder brother node adjacent to the i-th table-of-contents item on the same hierarchy layer. In the example of the table of contents in FIG. 13(a), for example, sib (4)=3 and sib (11)=5, and par(i) is a function which returns the table-of-contents item number of a parent node of the i-th table-of-contents item. In the example of the table of contents in FIG. 13(a), for example, par (4)=1 and cpar (5)=0. In addition to the above two functions, a function chd(i) which returns the table-of-contents item number of the last child node of the i-th table-of-contents item is introduced. In the example of the table of contents in FIG. 13(a), for example, chd(0)=11 and chd(1)=4. Pseudocodes of the newly introduced three functions are described below.

par(n)://the first item which is positioned before n and the hierarchy level
of which is smaller than n
for i in {n−1, n−2, ..., 0}:
if L[i]<L[n]:
return i
return −1
sib(n):// the first item which is positioned before n and after par(n) and the
hierarchy level of which is the same as n
for i in {n−1, n−2, ..., par(n)+1}:
if L[i]==L[n]:
return i
return −1
chd(n)://the last item which is positioned after n and before items on the
same hierarchy level as n and the hierarchy level of which is larger than n
by one
c=−1
for i in{n+1, ..., |L|}:
if L[i]==L[n]:
return c
else if L[i]==L[n]+1:
c=i
return c

On the right side of Definition 6, the sum of the unigram scores u of the first term is the sum for all table-of-contents items. The sum of the sibling bigram scores b1 of the second term is the sum for all pairs of adjacent table-of-contents items in a sibling relationship. The sum of the parent-child bigram scores b2 of the third term is the sum for all pairs of table-of-contents items in a parent-child relationship. Since methods for designing each score for the unigram score u and the sibling bigram score b1 is the same as the methods for the unigram score u and the bigram score b described with regard to the example 1, respectively, description thereof is omitted here. The method for designing the parent-child bigram score b2 will be described below. After that, the method for searching for the maximum value of the score function S expressed by Definition 6 will be described.

The parent-child bigram score b2(i, mᵢ, mₚₐᵣ₍ᵢ₎, C, D) is a score evaluating the likelihood of associations of a pair of one table-of-contents item (the i-th table-of-contents item (C[i])) and a table-of-contents item which is a parent of said one table-of-contents item (the par(i)th table-of-contents item (C[par(i)])), that is, paired table-of-contents items in a parent-child relationship with heading candidate lines (the mᵢ-th line (D[mᵢ]) and the mₚₐᵣ₍ᵢ₎th line (D[mₚₐᵣ₍ᵢ₎])) on the basis of the degree of commonality between the associations of the paired table-of-contents items in the parent-child relationship with their respective heading candidate lines. As described above, evaluation of the commonality degree of the parent-child bigram score b2 is higher as the commonality degree is lower.

The first example of the evaluation based on the commonality degree is evaluation based on the degree of commonality between formats. That is, the parent-child bigram score b2 is designed so that a high score is returned if the degree of commonality between the formats of D[mᵢ] with which a child table-of-contents item C[i] is associated and D[mₚₐᵣ₍ᵢ₎] with which a parent table-of-contents item C[par(i)] is associated is low. More specifically, the parent-child bigram score b2 is designed so that a high score is returned if there is a large-small relationship between the font size of D[mᵢ] corresponding to the child table-of-contents item C[i] and the font size of D[mₚₐᵣ₍ᵢ₎] corresponding to the parent table-of-contents item C[par(i)]. This is based on the knowledge that the font size of a parent heading is generally larger than that of a child heading.

Instead of or in addition to the font size described above, the parent-child bigram score b2 may be designed so that a high score is returned if the format of the index part of D[mᵢ] corresponding to the child table-of-contents item C[i] is different from the format of the index part of D[mₚₐᵣ₍ᵢ₎] corresponding to the parent table-of-contents item C[par(i)]. Examples of the case where the formats of index parts are different from each other will be shown below. When expressed in the form of “parent index part-child index part”, the examples are Part 1-Chapter 1, Chapter 1-1.1, 1.1-1.1.1, 1-(1), (1)-(a) and the like. However, the case is not limited thereto. As an example of judgment of the format of an index part, regular expressions of formats of index parts are prepared in advance to perform matching with these regular-expression formats. If the formats match with different regular-expression formats, the formats can be judged to be different from each other. For example, for “Chapter 1” and “1.1”, regular expressions as shown below can be prepared.

/Chapter ([0-9]+)/

/([0-9+])¥.([0-9]+)

As a variation, the regular expression of “Chapter II” is as follows:

/Chapter([I II III IV V VI VII VIII IX]+)/

In the case of using not “.” but “-” like “1-1”, the regular expression is as follows:

/([0-9+])-([0-9]+)/

For other formats, regular expressions can be prepared similarly.

The second example of the evaluation based on the commonality degree is evaluation based on the degree of commonality between differences, the difference being difference between a page number in a table of contents and an actual page number, that is, a sequential number beginning with the first page. For the second example, however, the parent-child bigram score b2 is designed so that a higher score is returned as the commonality degree is higher. That is, the parent-child bigram score b2 can designed so that a high score is returned if the commonality between the difference between a page number included in C[i] and the sequential number of a page which includes D[mᵢ] associated with C[i] and the difference between a page number included in C[par(i)] and the sequential number of a page which includes D[mₚₐᵣ₍ᵢ₎] associated with C[par(i)] is high. As an example, the degree of commonality between the differences may be judged to be high if the differences are the same.

The parent-child bigram score b2 may be such that evaluation is performed by combining any number of evaluations (scores) among the three evaluations (scores) based on the commonality degree described above while performing weighting. In the case of summing up multiple evaluations (scores) to perform evaluation, even if all the evaluations (scores) cannot be acquired because, for some of associations, font size or page information cannot be acquired, it does not matter if any one of the evaluations (scores) can be determined. In the weighting, the weight of each score may be automatically learned from correct data.

Next, a method for calculating the maximum value of the score function S expressed by Definition 6 will be described. The series of the associations M which maximize the score function S expressed by Definition 6 can be determined as time complexity O(|C∥D|³) by applying the 2^{nd} order Eisner algorithm. Therefore, the actual calculation time can be further reduced by filtering the elements of body data D, that is, heading candidate lines. As an example, the filtering based on the degree of similarity between the character strings of a table-of-contents item and a heading candidate line associated with the table-of-contents item, which has been described with regard to the example 1, can be applied. A method for searching for the maximum value of the score function S to which the 2^{nd} order Eisner algorithm is applied will be described below.

First, the expressions of the unigram score u and the bigram score b are simplified as described below for simplification of the description. In the description below, each of i, l and r is assumed to be an integer indicating a position in a document, that is, a line number. A unigram score u(c, i) indicates the unigram score u when the c-th table-of-contents item is associated with a heading candidate line of the i-th line. A sibling bigram score b1 (c, sib(c), i, l) indicates the sibling bigram score b1 when the c-th table-of-contents item is associated with the heading candidate line of the i-th line and the sib(c)th table-of-contents item in a sibling relationship therewith is associated with a heading candidate line of the l-th line. A parent-child bigram score b2(c, par(c), i, l) indicates the parent-child bigram score b2 when the c-th table-of-contents item is associated with the heading candidate of the i-th line and the par(c)th table-of-contents item in a parent-child relationship therewith is associated with the heading candidate line of the l-th line.

Next, two kinds of recursive functions are newly introduced. A recursive function comp(c, l, r) is assumed to be a function which returns the maximum score at the time when a sub-tree of a table of contents, with the c-th table-of-contents item as a root, is associated with a range in a document corresponding to the line numbers of {l, . . . , r−1}. The c-th table-of-contents item is assumed to correspond to the l-th line. A recursive function INCOMP(c, l, r) is assumed to be a function which returns the maximum score at the time when a set of sub-trees of a table of content gathered for all elder brother table-of-contents items is associated with a range in a document corresponding to the line numbers of {l+1, . . . , r−1}, the sub-tree being a sub-tree with a table-of-contents item corresponding to an elder brother of the c-th table-of-contents item as a root. It is assumed that the c-th table-of-contents item corresponds to the r-th line, and the par(c)th table-of-contents item corresponds to the l-th line.

Then, the recursive functions comp(c, l, r) and INCOMP(c, l, r) can be calculated by the following two recursive expressions. It is assumed that the symbol maxᵢ{G} indicates the maximum value of G if the value of G depends on i.

Recursive expression 1:

comp(c, l, r)=maxᵢ{incomp(chd(c), l, i)+comp(chd(c), i, r)+u(chd(c), i)+b2(c, chd(c), l, i)}

Recursive expression 2:

incomp(c, l, r)=maxᵢ{incomp(sib(c), l, i)+comp(sib(c), i, r)+u(sib(c), i)+b2(par(c), sib(c), l, i)+b1(sib(c), c, i, r)} - (Recursive expression 2)

Recursive expression 1 is a result of rewriting comp(c, l, r) using the symbol max; on the assumption that the chd(c)th table-of-contents item is associated with the i-th line. That is, in the above assumption, a set of sub-trees of a table of content gathered for all elder brother table-of-contents items is associated with a range corresponding to the line numbers of {l+1, . . . , i−1}, the sub-tree being a sub-tree with a table-of-contents item corresponding to an elder brother of the chd(c)th table-of-contents item as a root. The sub-tree of the table of contents with the chd(c)th table-of-contents item as a root is associated with a range corresponding to the line numbers of {i, . . . , r−1}. It should be noted that the c-th table-of-contents item is associated with the l-th line on the basis of the definition of comp(c, l, r).

Recursive expression 2 is a result of rewriting INCOMP(c, l, r) using the symbol max; on the assumption that the sib(c)th table-of-contents item is associated with the i-th line. That is, in the above assumption, a set of sub-trees of a table of content gathered for all elder brother table-of-contents items is associated with a range corresponding to the line numbers of {l+1, . . . , i−1}, the sub-tree being a sub-tree with a table-of-contents item corresponding to an elder brother of the sib(c)th table-of-contents item as a root. The sub-tree of the table of contents with the sib(c)th table-of-contents item as a root is associated with a range corresponding to the line numbers of {i, . . . , r−1}. It should be noted that the c-th table-of-contents item is associated with the r-th line and the par(c)th table-of-contents item is associated with the l-th line on the basis of the definition of INCOMP(c, l, r).

Searching for the maximum value of the score function S is equal to determining the maximum score of the whole three of a table of contents by the recursive function comp(c, l, r). That is, the maximum value of the score function S is determined as comp(0, 0, |D|+1) with the use of the above recursive function. The associations M between a table of contents and headings in a body which maximizes the score function S is determined as a set of associations, the associations including association of the chd(c)th table-of-contents item which gives the maximum value in each calculation of comp(c, l, r) that is recursively called at the time of determining comp(0, 0, |D|+1) and association of the sib(c)th table-of-contents item which gives the maximum value in each calculation of INCOMP(c, l, r) that is recursively called similarly.

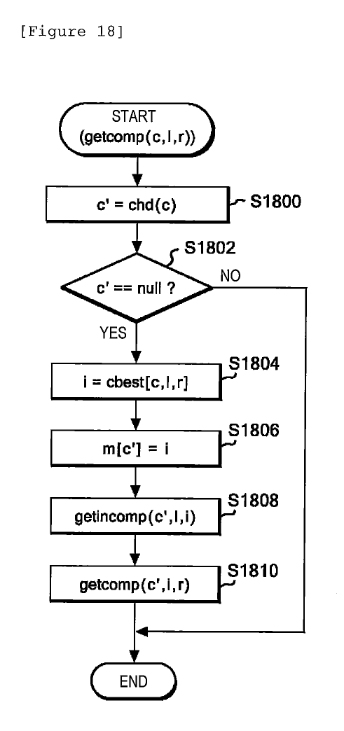

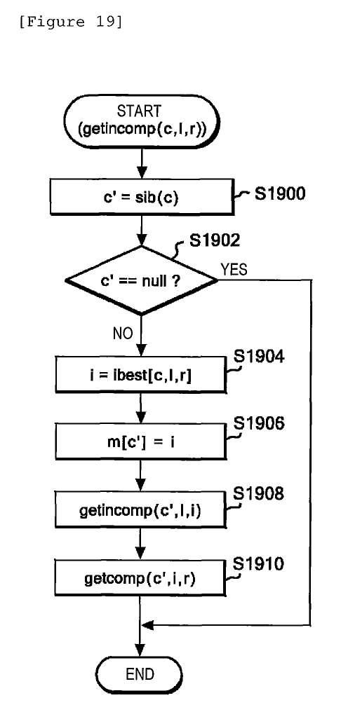

In this embodiment, further two recursive functions are prepared to output the above set of associations as associations M. A first recursive function GETCOMP(c, l, r) is a recursive function which calls a second recursive function to be described later and itself after setting the association of the chd(c)th table-of-contents item which gives the maximum value in the calculation of COMP(c, l, r) for M[chd(c)]. The second recursive function GETINCOMP(c, l, r) is a recursive function which calls itself and the first recursive function after setting the association of the sib(c)th table-of-contents item which gives the maximum value in the calculation of INCOMP(c, l, r) for M[sib(c)]. The details of methods for calculating these two recursive functions will be described with reference to flowcharts shown in FIGS. 18 and 19.

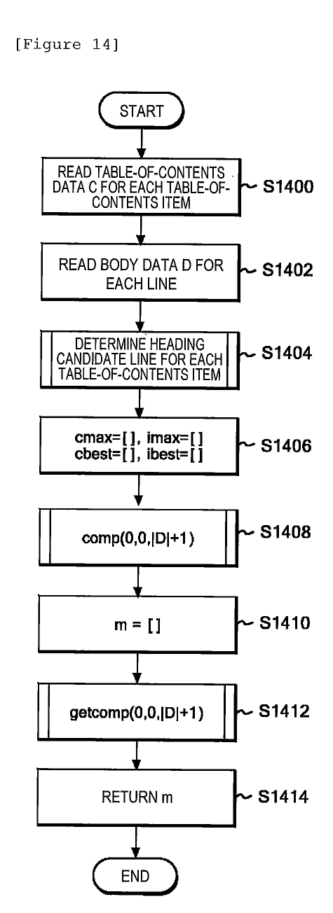

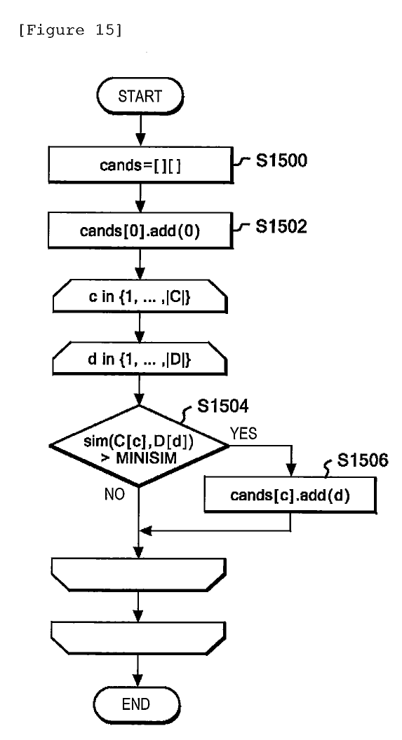

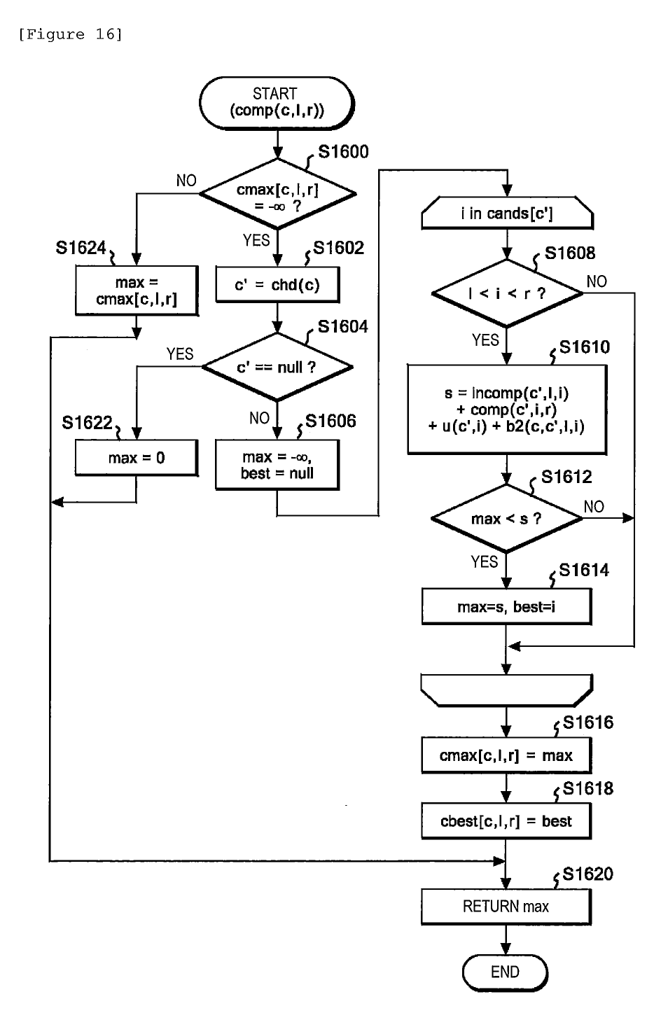

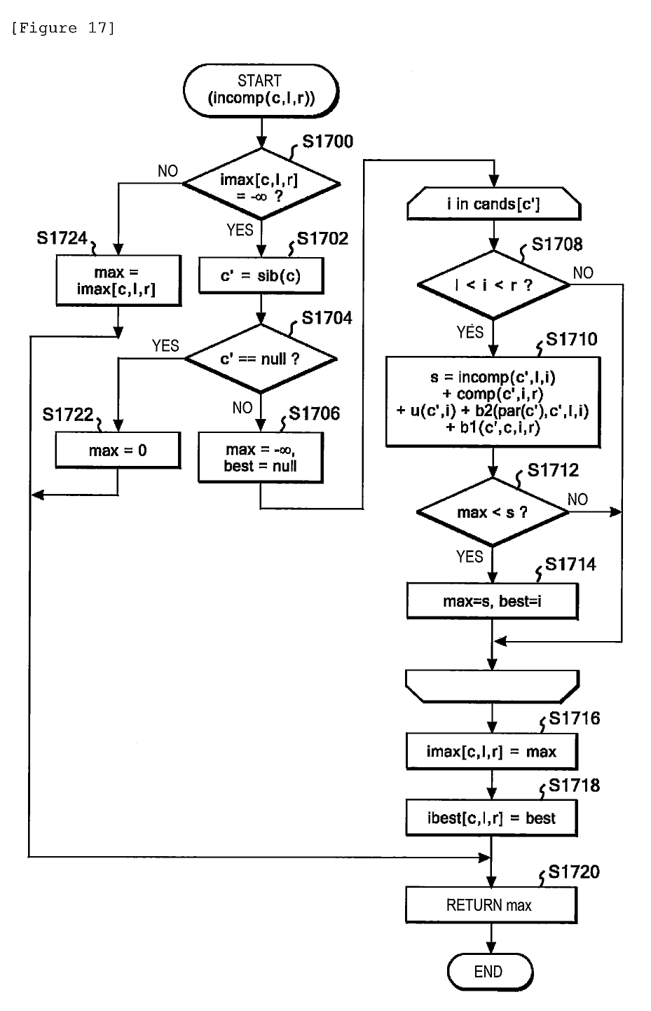

FIGS. 14 to 19 are used to describe an illustrative flow of a process by the apparatus 300 for automatic association between table of contents and headings according to Example 2. FIG. 14 is a flowchart showing an example of the flow of the whole process by the automatic association apparatus 300. FIG. 15 is a flowchart showing an example of the flow of a heading candidate line decision process at step 1404 of the flowchart shown in FIG. 14. FIG. 16 is a flowchart showing an example of the flow of a recursive function comp(c, l, r) calculation process. FIG. 17 is a flowchart showing an example of the flow of a recursive function INCOMP(c, l, r) calculation process. FIG. 18 is a flowchart showing an example of the flow of a recursive function GETCOMP(c, l, r) process. FIG. 19 is a flowchart showing an example of the flow of a recursive function GETINCOMP(c, l, r) process.

First, the flow of the illustrative process of automatic association between a table of contents and a heading will be described with reference to FIG. 14. The illustrative process of automatic association shown in FIG. 14 starts at step 1400, where the automatic association apparatus 300 inputs table-of-contents data C for each table-of-contents item and body data D for each line from a storage device or from another computer via a network (steps 1400 and 1402). Subsequently, the automatic association apparatus 300 uses the inputted table-of-contents data C and body data D to decide a heading candidate line for which association should be examined, for each table-of-contents item (step 1404). The details of the heading candidate line decision process will be described with reference to FIG. 15.

Subsequently, the automatic association apparatus 300 prepares hash tables cmax, imax, cbest and ibest which take a set of three integers and initializes each table with −∞ (step 1406). Here, cmax is a hash table which returns the maximum value of the recursive function comp(c, l, r) with (c, l, r) as a key; imax is a hash table which returns the maximum value of the recursive function INCOMP(c, l, r) with (c, l, r) as a key; cbest is a hash table which returns a result of association of the chd(c)th table-of-contents item which gives the maximum value in the calculation of the recursive function comp(c, l, r) with (c, l, r) as a key; and ibest is a hash table which returns a result of association of the sib(c)th table-of-contents item which gives the maximum value in the calculation of the recursive function INCOMP(c, l, r) with (c, l, r) as a key.

Subsequently, the automatic association apparatus 300 calls comp(0, 0, |D|+1) and determines the maximum value of the score function S (step 1408). The details of the COMP(0, 0, |D|+1) calling process will be described with reference to FIG. 16 instead of the details of the recursive function COMP(c, l, r) calculation process. Subsequently, the automatic association apparatus 300 prepares an array of m of associations M (step 1410). Subsequently, the automatic association apparatus 300 calls GETCOMP(0, 0, |D|+1) and sets associations which maximize the score function S for the array m (step 1412). The details of the GETCOMP(0, 0, |D|+1) calling process will be described with reference to FIG. 18 instead of the details of the recursive function GETCOMP (c, l, r) calculation process. Lastly, the automatic association apparatus 300 outputs the array m as associations between a table of contents and headings to be determined (step 1414). Then, the illustrative process ends.

FIG. 15 concerns the details of the heading candidate line determination process. Here, the second filtering based on the degree of similarity between character strings, which has been described with regard to the example 1 is used to limit heading candidate lines. The heading candidate line determination process shown in, FIG. 15 starts at step 1500, and the automatic association apparatus 300 prepares a two-dimensional array cands first. Setting of a value for each element of the two-dimensional array cands is performed in the subsequent process. It is assumed that, for the c-th table-of-contents item, cands[c] indicates an array of heading candidate lines for which association with the c-th table-of-contents item is to be examined.

After preparing the two-dimensional array cands, the automatic association apparatus 300 subsequently sets 0 for an element cands[0] of the two dimensional array cands (step 1502). Subsequently, the automatic association apparatus 300 repeats the processing of step 1504 and, if applicable, the processing of step 1506 by a first loop and a second loop. The first loop is a loop which repeats while incrementing a variable c by 1 from 1 to the number of table-of-contents items |C|. The second loop is a loop which repeats while incrementing a variable d by 1 from 1 to the number of all lines in a body |D| relative to the value of the variable c.

At step 1504, the automatic association apparatus 300 judges whether the degree of similarity between the character string of the c-th table-of-contents item C[c] and the character string of the d-th line D[d] is above the minimum acceptable similarity degree MINSIM or not. As already described, an existing technique such as the editing distance can be used for the judgment of the similarity degree. If the similarity degree is above MINSIM (step 1504: YES), then the automatic association apparatus 300 adds the d-th line to cands[c] as a heading candidate line (step 1506). If the similarity degree is equal to or below MINSIM (step 1504: NO) or after the processing of step 1506, the automatic association apparatus 300 repeats the above series of processings until it exits all the first and second loops. Then, the illustrative process ends.

FIG. 16 concerns the details of the recursive function COMP(c, l, r) calculation process. The recursive function COMP(c, l, r) calculation process shown in FIG. 16 starts at step 1600, and the automatic association apparatus 300 judges whether cmax(c, l, r) is equal to −∞ or not. This is done for the purpose of, if COMP has already been calculated for the same argument, reusing the result because COMP is a recursive function. If cmax(c, l, r)≠−∞ is satisfied (step 1600: NO), that is, if the value of comp has already been calculated for the current argument, the automatic association apparatus 300 proceeds to step 1624 and sets the value of cmax[c, l, r] for a variable max. On the other hand, if the value of cmax(c, l, r) is −∞ (step 1600: YES), that is, the value of comp has not been calculated yet for the current argument, the automatic association apparatus 300 sets the value of chd(c) for a variable c′ (step 1602).

Subsequently, the automatic association apparatus 300 judges whether the value of the variable c′ is null or not (step 1604). If the value of the variable c′ is null (step 1604: YES), that is, there is not a table-of-contents item in a child relationship with c-th table-of-contents item, the automatic association apparatus 300 proceeds to step 1622 and sets 0 for the variable max. On the other hand, if the value of the variable c′ is not null (step 1604: NO), the automatic association apparatus 300 prepares a variable max for determining the maximum value of the right side of the recursive expression 1 described above and initializes the variable max with −∞ (step 1606). The automatic association apparatus 300 also prepares a variable best for holding association of the chd(c)th table-of-contents item which gives the above maximum value of the right side and initializes the variable best with 0.

Subsequently, the automatic association apparatus 300 repeats the process from the subsequent step 1608 to step 1614 by a loop in order to determine the maximum value of the right side of the recursive expression 1. Here, the loop is a loop which repeats while sequentially taking out one heading candidate line (the i-th line) from an array of heading candidate lines for the c′-th table-of-contents item. At step 1608, the automatic association apparatus 300 judges whether l<i<r is satisfied or not. This is done for the purpose of confirming that the line number of a heading candidate line (the i-th line) corresponding to the c′-th table-of-contents item is included within the range of {l+1, . . . , r−1}. If l<i<r is satisfied (step 1608: YES), the automatic association apparatus 300 prepares a variable s and sets the value of incomp(c′, l, i)+comp(c′, i, r)+u(c′, i)+b2(c, c′, l, i) for the variable s (step 1610). The details of the recursive function INCOMP calculation process will be described with reference to FIG. 17.

Subsequently, the automatic association apparatus 300 judges whether max<s is satisfied or not (step 1612). If max<s is satisfied (step 1612: YES), the automatic association apparatus 300 sets the value of the variable s for the variable max and the value of a variable i for the variable best (step 1614). If l<i<r is not satisfied at step 1608, if max<s is not satisfied at step 1612, or after step 1614, the automatic association apparatus 300 repeats the series of processings until it exits the loop described above.

When having exited the loop, the automatic association apparatus 300 subsequently sets the value of the variable max as the value of a hash table cmax[c, l, r] and the value of the variable best as the value of a hash table cbest[c, l, r] (steps 1616 and 1618). The automatic association apparatus 300 proceeds to step 1620 from step 1622, 1624 or 1618 and returns the value of the variable max. Then, the process ends.

FIG. 17 concerns the details of the recursive function INCOMP(c, l, r) calculation process. The recursive function INCOMP(c, l, r) calculation process shown in FIG. 17 starts at step 1700, and the automatic association apparatus 300 judges whether imax(c, l, r) is equal to −∞ or not. This is done for the purpose of, if INCOMP has already been calculated for the same argument, reusing the result because INCOMP is a recursive function. If imax(c, l, r)≠−∞ is satisfied (step 1700: NO), that is, if the value of INCOMP has been already calculated for the current argument, the automatic association apparatus 300 proceeds to step 1724 and sets the value of imax[c, l, r] for a variable max. On the other hand, if the value of imax(c, l, r) is -co (step 1700: YES), that is, the value of INCOMP has not been calculated yet for the current argument, the automatic association apparatus 300 sets the value of sib(c) for a variable c′ (step 1702).

Subsequently, the automatic association apparatus 300 judges whether the value of the variable c′ is null or not (step 1704). If the value of the variable c′ is null (step 1704: YES), that is, there is not a table-of-contents item in an elder brother relationship with the c-th table-of-contents item, the automatic association apparatus 300 proceeds to step 1722 and sets 0 for the variable max. On the other hand, if the value of the variable c′ is not null (step 1704: NO), the automatic association apparatus 300 prepares a variable max for determining the maximum value of the right side of the recursive expression 2 described above and initializes the variable max with −∞ (step 1706). The automatic association apparatus 300 also prepares a variable best for holding association of the sib(c)th table-of-contents item which gives the above maximum value of the right side and initializes the variable best with 0.

Subsequently, the automatic association apparatus 300 repeats the process from the subsequent step 1708 to step 1714 by a loop in order to determine the maximum value of the right side of the recursive expression 2. Here, the loop is a loop which repeats while sequentially taking out one heading candidate line (the i-th line) from an array of heading candidate lines for the c′-th table-of-contents item. At step 1708, the automatic association apparatus 300 judges whether l<i<r is satisfied or not. This is done for the purpose of confirming that the line number of a heading candidate line (the i-th line) corresponding to the c′-th table-of-contents item is included within the range of {l+1, . . . , r−1}. If l<i<r is satisfied (step 1708: YES), the automatic association apparatus 300 prepares a variable s and sets the value of INCOMP(c′, l, i)+comp(c′, i, r)+u(c′, i)+b2(par(c′), c′, l, i)+b1 (c′ c, i, r) for the variable s (step 1710).

Subsequently, the automatic association apparatus 300 judges whether max<s is satisfied or not (step 1712). If max<s is satisfied (step 1712: YES), the automatic association apparatus 300 sets the value of the variable s for the variable max and the value of the variable i for the variable best (step 1714). If l<i<r is not satisfied at step 1708, if max<s is not satisfied at step 1712, or after step 1714, the automatic association apparatus 300 repeats the series of processings until it exits the loop described above.

When having exited the loop, the automatic association apparatus 300 subsequently sets the value of the variable max as the value of a hash function imax[c, l, r] and the value of the variable best as the value of a hash function ibest[c, l, r] (steps 1716 and 1718). The automatic association apparatus 300 proceeds to step 1720 from step 1722, 1724 or 1718 and returns the value of the variable max. Then, the process ends.

Looking at FIG. 13(b), the order of restoring the array of associations M will now be described before describing the flow of calculation processes of the recursive functions “GETCOMP” and “GETINCOMP.” In the restoration order shown in FIG. 13(b), the table of contents shown in FIG. 13(a) is used as an example, and numerals below table-of-contents items shown in rectangles indicate the restoration order. Seen from the numerals, the restoration order is such that a lower hierarchy level is earlier, and a position to the right is earlier in the same hierarchy layer.

FIG. 18 concerns the details of the recursive function getcomp(c, l, r) calculation process. The recursive function GETCOMP(c, l, r) calculation process shown in FIG. 18 starts at step 1800, and the automatic association apparatus 300 sets the value of chd(c) for a variable c′ and judges whether the value of the variable c′ is null or not (step 1802). If the value of the variable c′ is null (step 1804: YES), that is, there is not a table-of-contents item in a child relationship with the c-th table-of-contents item, the process ends.

On the other hand, if the value of the variable c′ is not null (step 1802: NO), the automatic association apparatus 300 sets the value of the hash function cbest[c, l, r] for a variable i (step 1804). Subsequently, the automatic association apparatus 300 sets the value of the variable i for an element m[c′] of the array of associations M (step 1806). Subsequently, the automatic association apparatus 300 calls a recursive function GETINCOMP(c′, l, i). The details of the recursive function GETINCOMP calculation process will be described with reference to FIG. 19. Subsequently, the automatic association apparatus 300 calls GETCOMP(c′, i, r). Then, the illustrative process ends.

FIG. 19 concerns the details of the recursive function GETINCOMP(c, l, r) calculation process. The recursive function GETINCOMP(c, l, r) calculation process shown in FIG. 19 starts at step 1900, and the automatic association apparatus 300 sets the value of sib(c) for a variable c′ and judges whether the value of the variable c′ is null or not (step 1902). If the value of the variable c′ is null (step 1904: YES), that is, there is not a table-of-contents item in an elder brother relationship with the c-th table-of-contents item, the illustrative process ends.

On the other hand, if the value of the variable c′ is not null (step 1902: NO), the automatic association apparatus 300 sets the value of the hash function ibest[c, l, r] for a variable i (step 1904). Subsequently, the automatic association apparatus 300 sets the value of the variable i for an element m[c′] of the array of associations M (step 1906). Subsequently, the automatic association apparatus 300 calls the recursive function GETINCOMP(c′, l, i). Subsequently, the automatic association apparatus 300 calls GETCOMP(c′, i, r). Then, the illustrative process ends.

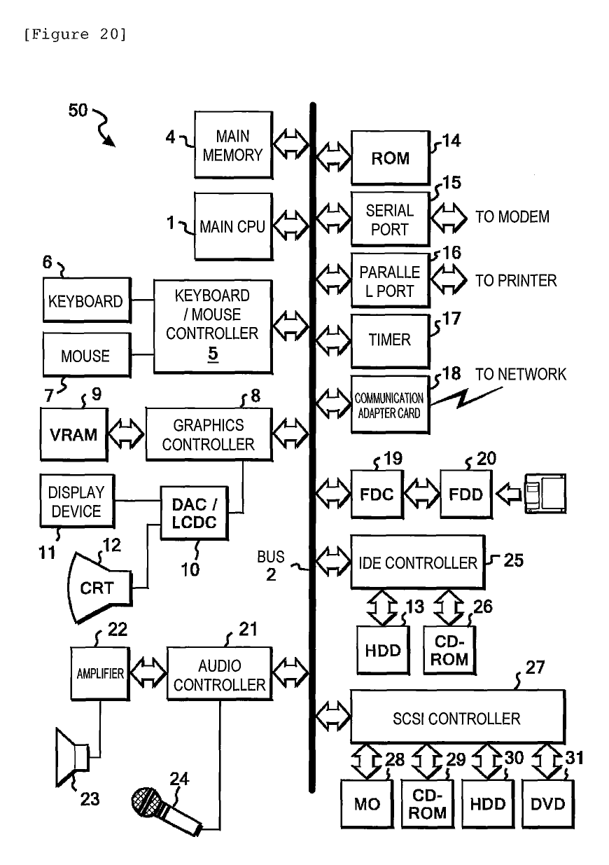

FIG. 20 is a diagram showing an example of the hardware configuration of a computer 50 according to this embodiment. The computer 50 includes a main CPU (central processing unit) 1 and a main memory 4 which are connected to a bus 2. Hard disk devices 13 and 30 and removable storages (external storage systems for which a recording medium is exchangeable) such as CD-ROM devices 26 and 29, a flexible disk device 20, an MO (Magneto-Optical) device 28 and a DVD device 31 are connected to the bus 2 via a flexible disk controller 19, an IDE controller 25, a SCSI controller 27 and the like.

Storage medium such as a flexible disk, an MO, a CD-ROM and a DVD-ROM are inserted into the removable storages. In such storage medium, the hard disk devices 13 and 30, or a ROM 14, the code of a computer program for giving an instruction to the CPU 1 in cooperation with an operating system to practice the disclosed embodiments can be recorded. That is, in a lot of storage devices described above, there can be recorded a program for automatic association between a table of contents and a heading which is installed in the computer 50 to cause the computer 50 as the automatic association apparatus 300, data such as table-of-contents data C and body data D and, further, output data M which is a result of automatic association.

The illustrative automatic association program described above includes an input module, a search module and an output module. These modules work on the CPU 1 to cause the computer 50 to function as an input section 302, a search section 304 and an output section 306. The computer program can be compressed or divided into multiple parts to be recorded in multiple media.

The computer 50 receives input from an input device such as a keyboard 6 and a mouse 7 via a keyboard/mouse controller 5. The computer 50 receives input from a microphone 24 and outputs voice from a speaker 23 via an audio controller 21. The computer 50 is connected to a display device 11 for presenting visual data to a user via a graphics controller 10. The computer 50 can be connected to a network via a network adapter 18 (an Ethernet (R) card or a token ring card) and the like and communicate with other computers and the like.

It will be appreciated that while various prior art does not disclose a technique about association between a table of contents and headings, the disclosed subject matter provides a technique capable of performing appropriate association between a table of contents and headings in a body using arithmetic processing by a computer in a computerized book without the need of comprehensively setting heading candidate limiting conditions in advance or manually setting them for each document.

From the above description, it will be easily understood that the computer 50 according to this embodiment is realized by an information processing apparatus such as an ordinary personal computer, workstation and mainframe or combination thereof. The components described above are only examples, and all the components are not necessarily essential for the invention as claimed in the application concerned.

This description of the various embodiments of the present invention have been presented for purposes of illustration, but it is not intended to be exhaustive or limited. The technical scope of the invention as claimed in the application concerned is not intended to be limited to the range described in the embodiments described herein. It is apparent to one skilled in the art that various modifications or improvements can be made in the disclosed embodiments. Therefore, embodiments obtained by such modifications or improvements are naturally included in the technical scope of the invention as claimed in the appended claims.

It should be noted that the order of executing operations, procedures, steps and processings of stages and the like in the apparatus, system, program and methods shown in the claims, the specification and the drawings is not especially specified clearly with the use of expressions of “before . . . ”, “prior to . . . ” and the like, and that the execution is possible in any order unless output of previous processing is used in subsequent processing. It should be also noted that even in the case of using output of previous processing in subsequent processing, it is sometimes possible to perform any other processing between the previous processing and the subsequent processing or that, even if it is described that any other processing is performed between the previous processing and the subsequent processing, it is sometimes possible to make a change so that the previous processing is performed immediately before the subsequent processing. Even if any operation flow in Claims, the specification and the drawings is described with the use of expressions of “first”, “next”, “subsequently” and the like for convenience, it does not necessarily mean that it is essential to implement the operation flow in that order.

1. A method implemented by a computing apparatus for associating a table of contents of a document, the table of contents having heading items, with one or more heading lines in a body of the document, the method comprising:
electronically receiving table-of-contents data C of the document for each table-of-contents item;
electronically receiving body data D of the document for each line;
electronically searching for a maximum value of a score function S that indicates the likelihood of associations M of all table-of-contents items in the table-of-contents data C with heading candidate lines that are lines as heading candidates in the body data D and that is a function of C, D and M; and
electronically outputting the associations M that maximize the score function S;
wherein the score function S is determined as the total of:
(a) a first sum obtained by summing up unigram scores u for all the table-of-contents items, the unigram score u evaluating the likelihood of association of each table-of-contents item with a heading candidate line independently, and
(b) a second sum obtained by summing up bigram scores b for all pairs of table-of-contents items, the bigram score b evaluating the likelihood of associations of paired table-of-contents items, which are a pair of one table-of-contents item and another table-of-contents item, with heading candidate lines on the basis of the degree of commonality between the associations of the paired table-of-contents items with the heading candidate lines.

2. The method according to claim 1, wherein:
the table of contents has a flat structure;
the unigram score u is determined on the basis of the degree of similarity between the character string of the table-of-contents item and the character string of the heading candidate line associated with the table-of-contents item; and
the bigram score b is determined on the basis of the degree of commonality between the formats of the heading candidate lines respectively associated with each of the paired table-of-contents items.

3. The method according to claim 2, wherein the bigram score b is determined further on the basis of the degree of commonality between differences in the associations of the paired table-of-contents items, the difference being difference between a page number included in the table-of-contents item and a sequential number of a page that includes a heading candidate line associated with the table-of-contents item.

4. The method according to claim 1, wherein said one table-of-contents item and said another table-of-contents item are adjacent to each other.

5. The method according to claim 4, wherein the table of contents has a tree structure, and said another table-of-contents item adjacent to said one table-of-contents item is limited to a table-of-contents item in a sibling relation of being adjacent to said one table-of-contents item on the same hierarchy layer in the tree structure of the table of contents.

6. The method according to claim 5, wherein the unigram score u is determined on the basis of the degree of similarity between the character string of the table-of-contents item and the character string of the heading candidate line associated with the table-of-contents item, and the bigram score b is determined on the basis of the degree of commonality between the formats of the heading candidate lines respectively associated with each of the paired table-of-contents items.

7. The method according to claim 6, wherein the degree of commonality between the formats is at least one of the degree of commonality between the font sizes of the heading candidate lines respectively associated with each of the paired table-of-contents items, the degree of commonality between the first characters or the first and last characters of the character strings of the heading candidate lines respectively associated with each of the paired table-of-contents items, and the degree of commonality between a predetermined number of characters in the character strings of the heading candidate lines respectively associated with each of the paired table-of-contents items, the predetermined number of characters being before and after a similar character string that is a part similar to the character string of the associated table-of-contents item.

8. The method according to claim 6, wherein the unigram score u is determined on the basis of the degree of similarity between the character string of the table-of-contents item and the character string of the heading candidate line associated with the table-of-contents item, and the bigram score b is determined further on the basis of the degree of commonality between differences in the associations of the paired table-of-contents items, the difference being difference between a page number included in the table-of-contents item and a sequential number of a page that includes the heading candidate line associated with the table-of-contents item.

9. The method according to claim 8, wherein the value of the bigram score b is decreased on condition that one heading candidate line associated with said one table-of-contents item and another heading candidate line associated with said another table-of-contents item are adjacent to each other.

10. The method according to claim 4, wherein table-of-contents items adjacent to said one table-of-contents item include such a table-of-contents item that is adjacent to said one table-of-contents item with a predetermined number of or fewer table-of-contents items therebetween.

11. The method according to claim 4, wherein the maximum value of the score function S is searched for in accordance with the Viterbi algorithm.

12. The method according to claim 4, wherein the maximum value of the score function S is searched for in accordance with the Dijkstra method.

13. The method according to claim 4, wherein, in the search for the maximum value of the score function S, the heading candidate line associated with each table-of-contents item included in the table-of-contents data C is limited to such a line that the character string thereon has a predetermined or higher degree of similarity to the character string of the table-of-contents item, among all lines in the body data D.

14. The method according to claim 1, wherein:
the table of contents has a tree structure;
a sibling bigram score b1 that returns a higher score value as the degree of commonality between the formats of the heading candidate lines associated with the paired table-of-contents items is higher is adopted as the bigram score b, for the paired table-of-contents items in a sibling relationship of being adjacent to each other on the same hierarchy layer in the tree structure; and
a parent-child bigram score b2 that returns a higher score value as the degree of commonality between the formats of the heading candidate lines associated with the paired table-of-contents items is lower is adopted as the bigram score b, for the pair of table-of-contents items in a parent-child relationship in the tree structure.

15. The method according to claim 14, wherein the parent-child bigram score b2 returns a high score value on condition that there is a large-small relationship between the font size of a heading candidate line associated with a parent table-of-contents item and the font size of a heading candidate line associated with a child table-of-contents item.

16. The method according to claim 14, wherein the parent-child bigram score b2 returns a high score value on condition that the formats of an index part of a heading candidate line associated with a parent table-of-contents item and an index part of a heading candidate line associated with a child table-of-contents item are different from each other.

17. The method according to claim 14, wherein the maximum value of the score function S is searched for in accordance with an algorithm to which 2^{nd} order Eisner is applied.

18. The method according to claim 17, including limiting, in the search for the maximum value of the score function S, the heading candidate line associated with each table-of-contents item included in the table-of-contents data C to such a line that includes a character string having a predetermined or higher degree of similarity to the character string of the table-of-contents item, among all lines in the body data D.

19. A program for association between a table of contents and headings, the program causing a computer to implement the method according to claim 1.

20. An apparatus for association between a table of contents and headings for associating a table-of-contents item in a table of contents of a document with a heading line in a body of the document, the apparatus comprising:
an input section for inputting table-of-contents data C for each table-of-contents item of the document and body data D for each line of the document;
a search section for searching for the maximum value of a score function S that indicates the likelihood of associations M of all table-of-contents items in the table-of-contents data C with heading candidate lines that are lines as heading candidates in the body data D and that is a function of C, D and M and; and
an output section for outputting the associations M that maximize the score function S;
wherein the search section determines the score function S as the total of a first sum obtained by summing up
(a) unigram scores u for all the table-of-contents items, the unigram score u evaluating the likelihood of association of each table-of-contents item with a heading candidate line independently, and
(b) a second sum obtained by summing up bigram scores b for all pairs of table-of-contents items, the bigram score b evaluating the likelihood of associations of paired table-of-contents items, which are a pair of one table-of-contents item and another table-of-contents item, with heading candidate lines on the basis of the degree of commonality between associations of the paired table-of-contents items with the heading candidate lines.
